(19) United States
(12) Patent Application Publication
(10) Pub. No.: US 2019/0053265 A1
(43) Pub. Date: Feb. 14, 2019

(54) METHOD FOR TRANSMITTING UPLINK CONTROL CHANNEL IN WIRELESS COMMUNICATION SYSTEM SUPPORTING UNLICENSED BAND AND DEVICE SUPPORTING SAME

(71) Applicant: LG ELECTRONICS INC., Seoul (KR)

(72) Inventors: Seonwook KIM, Seoul (KR); Joonkui AHN, Seoul (KR); Suckchel YANG, Seoul (KR); Hanjun PARK, Seoul (KR)

(73) Assignee: LG ELECTRONICS INC., Seoul (KR)

(21) Appl. No.: 16/086,291

(22) PCT Filed: Mar. 28, 2017
(86) PCT No.: PCT/KR2017/003307

§ 371 Date: Sep. 18, 2018

Related U.S. Application Data
(60) Provisional application No. 62/314,377, filed on Mar. 28, 2016.
(60) Provisional application No. 62/327,419, filed on Apr. 25, 2016.
(60) Provisional application No. 62/338,539, filed on May 19, 2016.
(60) Provisional application No. 62/340,518, filed on May 23, 2016.

(51) Int. Cl. H04W 72/12; H04W 74/08; H04W 72/04

(52) U.S. Cl. CPC H04W 72/1284; H04W 72/0446; H04W 74/08

(57) ABSTRACT

Disclosed in the present invention are a method for a terminal transmitting an uplink control channel to a base station in a licensed assisted access (LAA) system in which the base station or the terminal performs a listen-before-talk (LBT)-based signal transmission, and a device supporting same. To this end, the terminal receives, from the base station, downlink control information for scheduling uplink signal transmission from a plurality of unlicensed bands in an N^{th} subframe, and transmits uplink control information from the N^{th} subframe through at least one unlicensed band which has been successful in LBT from among the plurality of unlicensed bands, when the uplink control information to be transmitted us present in the N^{th} subframe.

### TECHNICAL FIELD

Following description invention relates to a wireless communication system supporting an unlicensed band, and more particularly, to a method for a user equipment to transmit uplink control information to a base station through at least one or more unlicensed bands in a wireless communication system supporting an unlicensed band and apparatuses therefor.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

### DISCLOSURE OF THE INVENTION

### Technical Tasks

An object of the present invention is to provide a method for a user equipment to transmit uplink control information to a base station via an unlicensed band.

In particular, since a user equipment is able to transmit an uplink signal to a base station via an unlicensed band only when the user equipment succeeds in performing LBT (Listen-Before-Talk) on the unlicensed band due to the characteristic of the unlicensed band, an object of the present invention is to provide a method for the user equipment to reliably transmit uplink control information, which is more important than other information, to the base station.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

The present invention provides a method for a user equipment to transmit uplink control information to a base station in a wireless communication system supporting an unlicensed band and apparatuses therefor.

To achieve these and other advantages and in accordance with the purpose of the present invention, as embodied and broadly described, according to one embodiment, a method of transmitting uplink control information, which is transmitted by a user equipment to a base station in a wireless communication system supporting an unlicensed band includes receiving downlink control information, which schedules uplink signal transmission on a plurality of unlicensed bands in an N^{th} (N is a natural number) subframe, from the base station, and if there is uplink control information to be transmitted in the N^{th} subframe, transmitting the uplink control information in the N^{th} subframe via at least one or more unlicensed band on which LBT (Listen-Before-Talk) is successfully performed among a plurality of the unlicensed bands.

To further achieve these and other advantages and in accordance with the purpose of the present invention, according to a different embodiment, a user equipment receiving a downlink signal from a base station in a wireless communication system supporting an unlicensed band includes a receiver, a transmitter, and a processor configured to operate in a manner of being connected with the receiver and the transmitter, the processor configured to receive downlink control information, which schedules uplink signal transmission on a plurality of unlicensed bands in an N^{th} (N is a natural number) subframe, from the base station, the processor, if there is uplink control information to be transmitted in the N^{th} subframe, configured to transmit the uplink control information in the N^{th} subframe via at least one or more unlicensed band on which LBT (Listen-Before-Talk) is successfully performed among a plurality of the unlicensed bands.

In this case, the transmission of the uplink control information can include transmission of the uplink control information transmitted via all unlicensed bands on which the LBT is successfully performed among a plurality of the unlicensed bands.

In this case, the uplink control information transmitted via all unlicensed bands on which the LBT is successfully performed may be all the same.

And, the uplink control information can be transmitted via a corresponding unlicensed band among the at least one or more unlicensed bands on which the LBT is successfully performed.

In this case, if the uplink control information is configured by a plurality of sub-uplink control information respectively corresponding to a plurality of the unlicensed bands, each of a plurality of the sub-uplink control information can be transmitted via a corresponding unlicensed band among the at least one or more unlicensed bands on which the LBT is successfully performed.

And, the uplink control information ca be transmitted via the at least one or more unlicensed bands on which the LBT is successfully performed only when the uplink control information includes aperiodic channel state information.

In this case, the uplink control information including the aperiodic channel state information can be transmitted via an unlicensed band corresponding to the uplink control information among the at least one or more unlicensed bands on which the LBT is successfully performed.

If it fails to perform the LBT on one or more unlicensed bands among a plurality of the unlicensed bands, the uplink control information may not be transmitted.

If the user equipment transmits a signal on at least one or more unlicensed bands prior to the N^{th} subframe, the uplink control information can be transmitted via the at least one or more unlicensed bands on which the signal is transmitted.

In this case, the uplink control information can include at least one selected from the group consisting of a rank indicator (RI), a precoding matrix indicator (PMI), a beam indicator (BI), channel quality information (CQI), channel state information (CSI), and reception confirmation information.

And, the uplink control information can be transmitted via a physical uplink shared channel (PUSCH).

To further achieve these and other advantages and in accordance with the purpose of the present invention, according to a further different embodiment, a method of transmitting uplink control information, which is transmitted by a user equipment to a base station in a wireless communication system supporting an unlicensed band includes receiving downlink control information, which schedules uplink signal transmission on at least one or more unlicensed bands in an N^{th} (N is a natural number) subframe, from the base station, and if there is uplink control information to be transmitted in the N^{th} subframe, transmitting the uplink control information in the N^{th} subframe via at least one or more unlicensed band on which LBT (Listen-Before-Talk) is successfully performed among a plurality of the unlicensed bands.

To further achieve these and other advantages and in accordance with the purpose of the present invention, according to a further different embodiment, a user equipment receiving a downlink signal from a base station in a wireless communication system supporting an unlicensed band includes a receiver, a transmitter, and a processor configured to operate in a manner of being connected with the receiver and the transmitter, the processor configured to receive downlink control information, which schedules uplink signal transmission on at least one or more unlicensed bands in an N^{th} (N is a natural number) subframe, from the base station, the processor, if there is uplink control information to be transmitted in the N^{th} subframe, configured to transmit the uplink control information in the N^{th} subframe via at least one or more unlicensed band on which LBT (Listen-Before-Talk) is successfully performed among a plurality of the unlicensed bands.

In this case, the uplink control information transmitted via the at least one or more unlicensed bands on which the LBT is successfully performed are all the same.

And, the uplink control information can include at least one selected from the group consisting of a rank indicator (RI), a precoding matrix indicator (PMI), a beam indicator (BI), channel quality information (CQI), channel state information (CSI), and reception confirmation information.

And, the uplink control information can be transmitted via a physical uplink shared channel (PUSCH).

Technical solutions obtainable from the present invention are non-limited the above-mentioned technical solutions. And, other unmentioned technical solutions can be clearly understood from the following description by those having ordinary skill in the technical field to which the present invention pertains.

### Advantageous Effects

As is apparent from the above description, the embodiments of the present disclosure have the following effects.

According to the present invention, a user equipment is able to reliably transmit uplink control information to a base station in a wireless access system supporting an unlicensed band.

In particular, according to the present invention, since a user equipment determines one or more unlicensed bands as an unlicensed band on which uplink control information is to be transmitted from among unlicensed bands on which LBT is successfully performed, although the user equipment fails to perform LBT on a specific unlicensed band, the user equipment is able to reliably transmit uplink control information to a base station.

Effects obtainable from the present invention are non-limited by the above mentioned effect. And, other unmentioned effects can be clearly understood from the following description by those having ordinary skill in the technical field to which the present invention pertains. That is, effects which are not intended by the present invention may be derived by those skilled in the art from the embodiments of the present invention.

### DESCRIPTION OF DRAWINGS

The accompanying drawings, which are included to provide a further understanding of the invention, provide embodiments of the present invention together with detail explanation. Yet, a technical characteristic of the present invention is not limited to a specific drawing. Characteristics disclosed in each of the drawings are combined with each other to configure a new embodiment. Reference numerals in each drawing correspond to structural elements.

FIG. 1 is a diagram illustrating physical channels and a signal transmission method using the physical channels;

FIG. 2 is a diagram illustrating exemplary radio frame structures;

FIG. 3 is a diagram illustrating an exemplary resource grid for the duration of a downlink slot;

FIG. 4 is a diagram illustrating an exemplary structure of an uplink subframe;

FIG. 5 is a diagram illustrating an exemplary structure of a downlink subframe;

FIG. 6 is a diagram illustrating an exemplary CA environment supported in an LTE-Unlicensed (LTE-U) system;

FIG. 7 is a diagram illustrating an exemplary Frame Based Equipment (FBE) operation as one of Listen-Before-Talk (LBT) operations;

FIG. 8 is a block diagram illustrating the FBE operation;

FIG. 9 is a diagram illustrating an exemplary Load Based Equipment (LBE) operation as one of the LBT operations;

FIG. 10 is a diagram for explaining methods of transmitting a DRS supported in an LAA system;

FIG. 11 is a flowchart for explaining CAP and CWA;

FIG. 12 is a diagram illustrating a partial TTI or a partial subframe applicable to the present invention;

FIG. 13 is a diagram briefly illustrating a method of transmitting UCI according to the first method of the present invention;

FIG. 14 is a diagram briefly illustrating a method of transmitting UCI according to the second method of the present invention;

FIG. 15 is a diagram briefly illustrating a method of transmitting UCI according to the third method of the present invention;

FIG. 16 is a diagram briefly illustrating a method of transmitting UCI according to the fourth method of the present invention;

FIG. 17 is a diagram briefly illustrating three cases of transmitting UCI information on an unlicensed band;

FIG. 18 is a diagram illustrating configurations of a UE and a base station in which proposed embodiments are implementable.

### BEST MODE

### Mode for Invention

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the attached drawings, a detailed description of known procedures or steps of the present disclosure will be avoided least it should obscure the subject matter of the present disclosure. In addition, procedures or steps that could be understood to those skilled in the art will not be described either.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a User Equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmission end is a fixed and/or mobile node that provides a data service or a voice service and a reception end is a fixed and/or mobile node that receives a data service or a voice service. Therefore, a UE may serve as a transmission end and a BS may serve as a reception end, on an UpLink (UL). Likewise, the UE may serve as a reception end and the BS may serve as a transmission end, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331. That is, the steps or parts, which are not described to clearly reveal the technical idea of the present disclosure, in the embodiments of the present disclosure may be explained by the above standard specifications. All terms used in the embodiments of the present disclosure may be explained by the standard specifications.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

For example, the term, TxOP may be used interchangeably with transmission period or Reserved Resource Period (RRP) in the same sense. Further, a Listen-Before-Talk (LBT) procedure may be performed for the same purpose as a carrier sensing procedure for determining whether a channel state is idle or busy, CCA (Clear Channel Assessment), and CAP (Channel Access Procedure).

Hereinafter, 3GPP LTE/LTE-A systems are explained, which are examples of wireless access systems.

The embodiments of the present disclosure can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE. While the embodiments of the present disclosure are described in the context of a 3GPP LTE/LTE-A system in order to clarify the technical features of the present disclosure, the present disclosure is also applicable to an IEEE 802.16e/m system, etc.

1. 3GPP LTE/LTE-A System

In a wireless access system, a UE receives information from an eNB on a DL and transmits information to the eNB on a UL. The information transmitted and received between the UE and the eNB includes general data information and various types of control information. There are many physical channels according to the types/usages of information transmitted and received between the eNB and the UE.

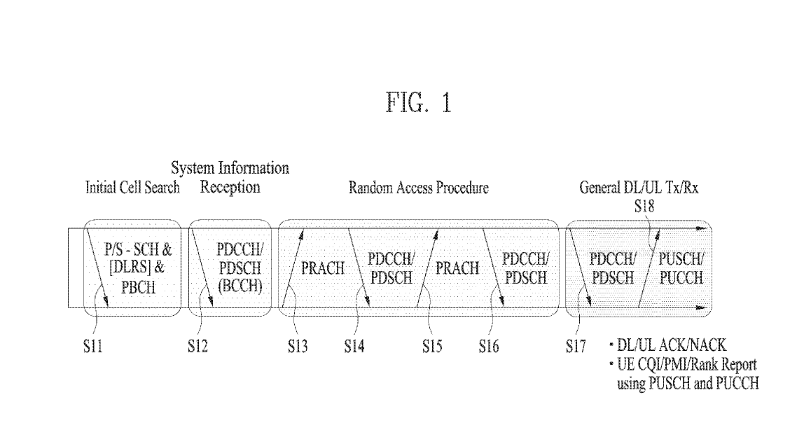

FIG. 1 illustrates physical channels and a general signal transmission method using the physical channels, which may be used in embodiments of the present disclosure.

When a UE is powered on or enters a new cell, the UE performs initial cell search (S11). The initial cell search involves acquisition of synchronization to an eNB. Specifically, the UE synchronizes its timing to the eNB and acquires information such as a cell Identifier (ID) by receiving a Primary Synchronization Channel (P-SCH) and a Secondary Synchronization Channel (S-SCH) from the eNB.

Then the UE may acquire information broadcast in the cell by receiving a Physical Broadcast Channel (PBCH) from the eNB.

During the initial cell search, the UE may monitor a DL channel state by receiving a Downlink Reference Signal (DL RS).

After the initial cell search, the UE may acquire more detailed system information by receiving a Physical Downlink Control Channel (PDCCH) and receiving a Physical Downlink Shared Channel (PDSCH) based on information of the PDCCH (S12).

To complete connection to the eNB, the UE may perform a random access procedure with the eNB (S13 to S16). In the random access procedure, the UE may transmit a preamble on a Physical Random Access Channel (PRACH) (S13) and may receive a PDCCH and a PDSCH associated with the PDCCH (S14). In the case of contention-based random access, the UE may additionally perform a contention resolution procedure including transmission of an additional PRACH (S15) and reception of a PDCCH signal and a PDSCH signal corresponding to the PDCCH signal (S16).

After the above procedure, the UE may receive a PDCCH and/or a PDSCH from the eNB (S17) and transmit a Physical Uplink Shared Channel (PUSCH) and/or a Physical Uplink Control Channel (PUCCH) to the eNB (S18), in a general UL/DL signal transmission procedure.

Control information that the UE transmits to the eNB is generically called Uplink Control Information (UCI). The UCI includes a Hybrid Automatic Repeat and reQuest Acknowledgement/Negative Acknowledgement (HARQ-ACK/NACK), a Scheduling Request (SR), a Channel Quality Indicator (CQI), a Precoding Matrix Index (PMI), a Rank Indicator (RI), etc.

In the LTE system, UCI is generally transmitted on a PUCCH periodically. However, if control information and traffic data should be transmitted simultaneously, the control information and traffic data may be transmitted on a PUSCH. In addition, the UCI may be transmitted aperiodically on the PUSCH, upon receipt of a request/command from a network.

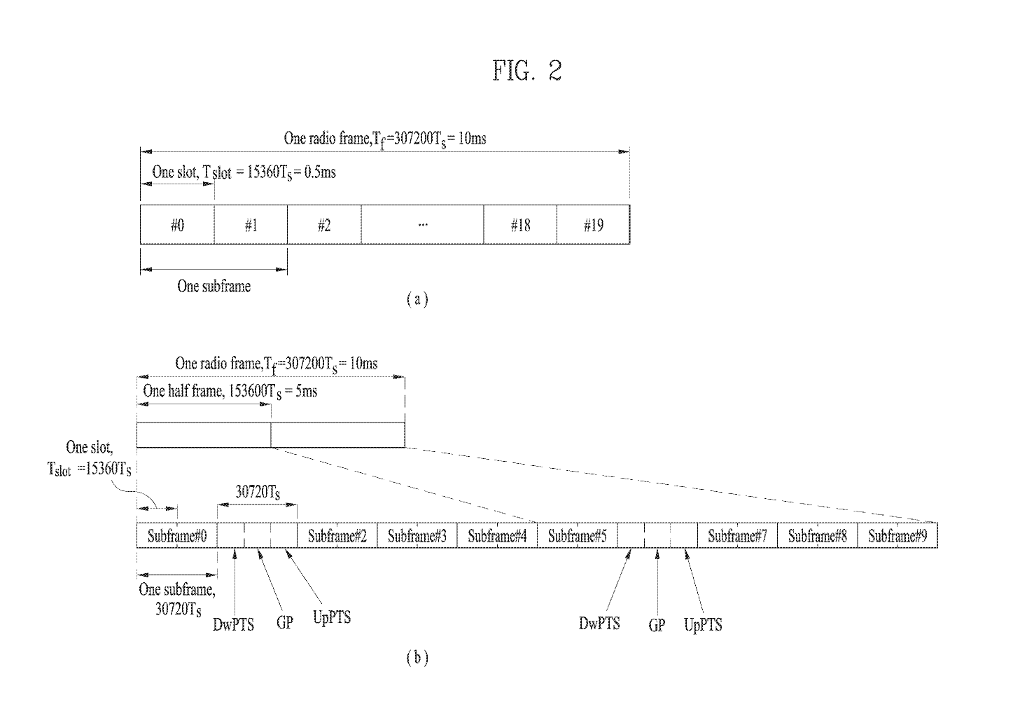

FIG. 2 illustrates exemplary radio frame structures used in embodiments of the present disclosure.

FIG. 2(a) illustrates frame structure type 1. Frame structure type 1 is applicable to both a full Frequency Division Duplex (FDD) system and a half FDD system.

One radio frame is 10 ms (Tf=307200·Ts) long, including equal-sized 20 slots indexed from 0 to 19. Each slot is 0.5 ms (Tslot=15360·Ts) long. One subframe includes two successive slots. An ith subframe includes 2ith and (2i+1)th slots. That is, a radio frame includes 10 subframes. A time required for transmitting one subframe is defined as a Transmission Time Interval (TTI). Ts is a sampling time given as Ts=1/(15 kHz×2048)=3.2552×10-8 (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

In a full FDD system, each of 10 subframes may be used simultaneously for DL transmission and UL transmission during a 10-ms duration. The DL transmission and the UL transmission are distinguished by frequency. On the other hand, a UE cannot perform transmission and reception simultaneously in a half FDD system.

The above radio frame structure is purely exemplary. Thus, the number of subframes in a radio frame, the number of slots in a subframe, and the number of OFDM symbols in a slot may be changed.

FIG. 2(b) illustrates frame structure type 2. Frame structure type 2 is applied to a Time Division Duplex (TDD) system. One radio frame is 10 ms (Tf=307200·Ts) long, including two half-frames each having a length of 5 ms (=153600·Ts) long. Each half-frame includes five subframes each being 1 ms (=30720·Ts) long. An ith subframe includes 2ith and (2i+1)th slots each having a length of 0.5 ms (Tslot=15360·Ts). Ts is a sampling time given as Ts=1/(15 kHz×2048)=3.2552×10-8 (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

[Table 1] below lists special subframe configurations (DwPTS/GP/UpPTS lengths).

TABLE 1

| | Normal cyclic prefix in downlink | | | | | |
|---|---|---|---|---|---|---|
| | | UpPTS | | Extended cyclic prefix in downlink | | |
| Special | | Normal | Extended | | UpPTS | |
| subframe | | cyclic prefix | cyclic prefix | | Normal cyclic | Extended cyclic |
| configuration | DwPTS | in uplink | in uplink | DwPTS | prefix in uplink | prefix in uplink |
| 0 | 6592 · T_{S} | 2192 · T_{S} | 2560 · T_{S} | 7680 · T_{S} | 2192 · T_{S} | 2560 · T_{S} |
| 1 | 19760 · T_{S} | | | 20480 · T_{S} | | |
| 2 | 21952 · T_{S} | | | 23040 · T_{S} | | |
| 3 | 24144 · T_{S} | | | 25600 · T_{S} | | |
| 4 | 26336 · T_{S} | | | 7680 · T_{S} | 4384 · T_{S} | 5120 · T_{S} |
| 5 | 6592 · T_{S} | 4384 · T_{S} | 5120 · T_{S} | 20480 · T_{S} | | |
| 6 | 19760 · T_{S} | | | 23040 · T_{S} | | |
| 7 | 21952 · T_{S} | | | 12800 · T_{S} | | |
| 8 | 24144 · T_{S} | | | — | — | — |
| 9 | 13168 · T_{S} | | | — | — | — |

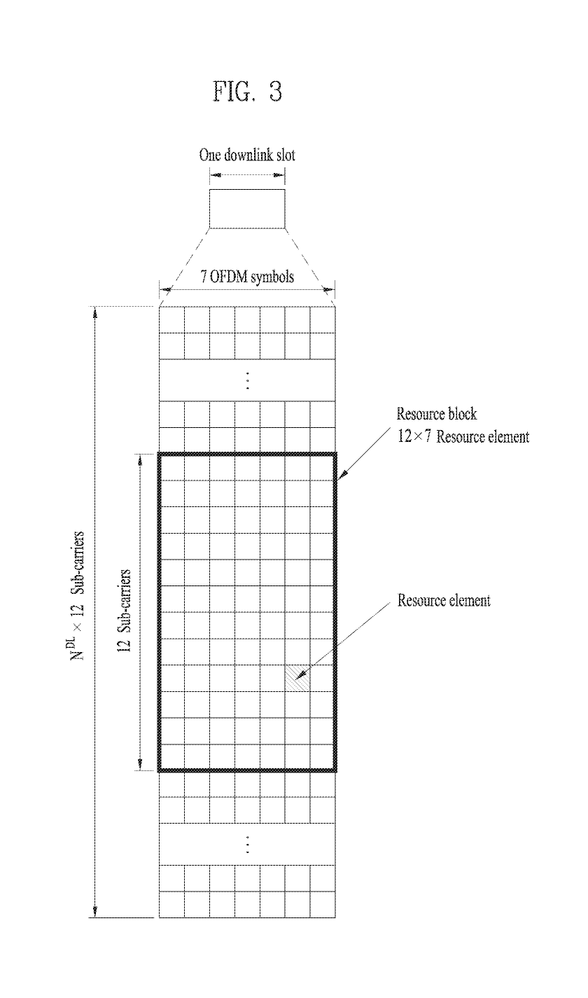

FIG. 3 illustrates an exemplary structure of a DL resource grid for the duration of one DL slot, which may be used in embodiments of the present disclosure.

Referring to FIG. 3, a DL slot includes a plurality of OFDM symbols in the time domain. One DL slot includes 7 OFDM symbols in the time domain and an RB includes 12 subcarriers in the frequency domain, to which the present disclosure is not limited.

Each element of the resource grid is referred to as a Resource Element (RE). An RB includes 12×7 REs. The number of RBs in a DL slot, NDL depends on a DL transmission bandwidth. A structure of an uplink slot may be identical to a structure of a downlink slot.

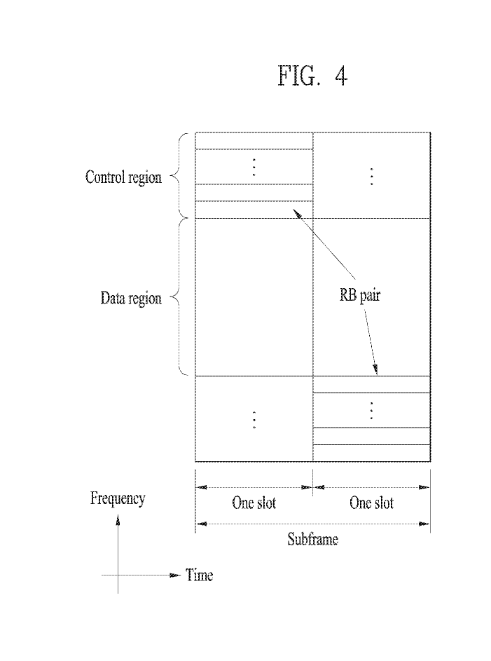

FIG. 4 illustrates a structure of a UL subframe which may be used in embodiments of the present disclosure.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe is allocated to a PUCCH for a UE. The RBs of the RB pair occupy different subcarriers in two slots. Thus it is said that the RB pair frequency-hops over a slot boundary.

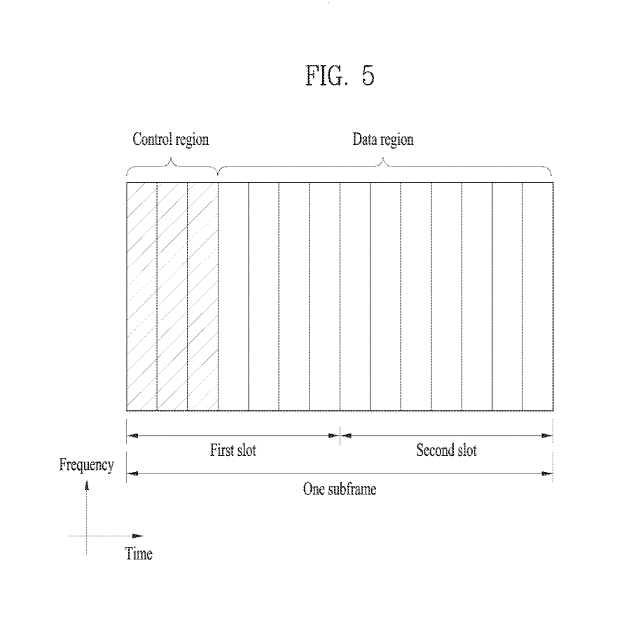

FIG. 5 illustrates a structure of a DL subframe that may be used in embodiments of the present disclosure.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e. the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

2. LTE-U System

2.1 LTE-U System Configuration

Hereinafter, methods for transmitting and receiving data in a CA environment of an LTE-A band corresponding to a licensed band and an unlicensed band will be described. In the embodiments of the present disclosure, an LTE-U system means an LTE system that supports such a CA status of a licensed band and an unlicensed band. A WiFi band or Bluetooth (BT) band may be used as the unlicensed band. LTE-A system operating on an unlicensed band is referred to as LAA (Licensed Assisted Access) and the LAA may correspond to a scheme of performing data transmission/reception in an unlicensed band using a combination with a licensed band.

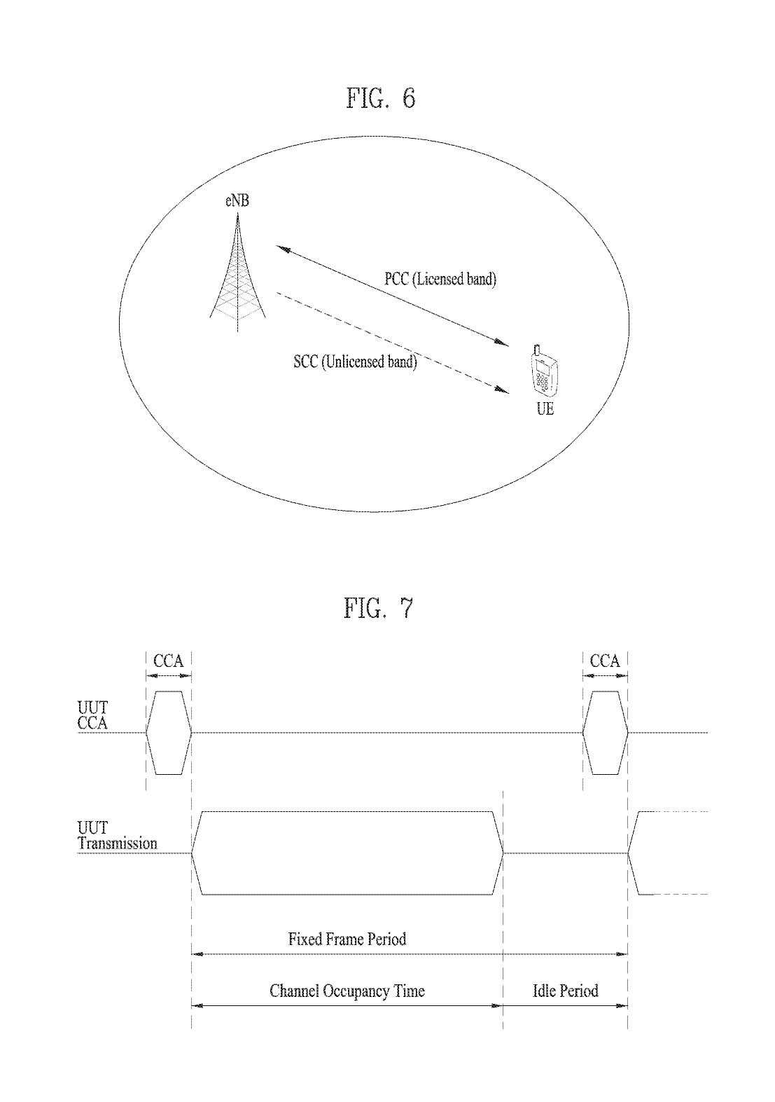

FIG. 6 illustrates an example of a CA environment supported in an LTE-U system.

Hereinafter, for convenience of description, it is assumed that a UE is configured to perform wireless communication in each of a licensed band and an unlicensed band by using two CCs. The methods which will be described hereinafter may be applied to even a case where three or more CCs are configured for a UE.

In the embodiments of the present disclosure, it is assumed that a carrier of the licensed band may be a primary CC (PCC or PCell), and a carrier of the unlicensed band may be a secondary CC (SCC or SCell). However, the embodiments of the present disclosure may be applied to even a case where a plurality of licensed bands and a plurality of unlicensed bands are used in a carrier aggregation method. Also, the methods suggested in the present disclosure may be applied to even a 3GPP LTE system and another system.

In FIG. 6, one eNB supports both a licensed band and an unlicensed band. That is, the UE may transmit and receive control information and data through the PCC which is a licensed band, and may also transmit and receive control information and data through the SCC which is an unlicensed band. However, the status shown in FIG. 6 is only example, and the embodiments of the present disclosure may be applied to even a CA environment that one UE accesses a plurality of eNBs.

For example, the UE may configure a macro eNB (M-eNB) and a PCell, and may configure a small eNB (S-eNB) and an SCell. At this time, the macro eNB and the small eNB may be connected with each other through a backhaul network.

In the embodiments of the present disclosure, the unlicensed band may be operated in a contention-based random access method. At this time, the eNB that supports the unlicensed band may perform a Carrier Sensing (CS) procedure prior to data transmission and reception. The CS procedure determines whether a corresponding band is reserved by another entity.

For example, the eNB of the SCell checks whether a current channel is busy or idle. If it is determined that the corresponding band is idle state, the eNB may transmit a scheduling grant to the UE to allocate a resource through (E)PDCCH of the PCell in case of a cross carrier scheduling mode and through PDCCH of the SCell in case of a self-scheduling mode, and may try data transmission and reception.

At this time, the eNB may configure a TxOP including N consecutive subframes. In this case, a value of N and a use of the N subframes may previously be notified from the eNB to the UE through higher layer signaling through the PCell or through a physical control channel or physical data channel.

2.2 Carrier Sensing (CS) Procedure

In embodiments of the present disclosure, a CS procedure may be called a Clear Channel Assessment (CCA) procedure. In the CCA procedure, it may be determined whether a channel is busy or idle based on a predetermined CCA threshold or a CCA threshold configured by higher-layer signaling. For example, if energy higher than the CCA threshold is detected in an unlicensed band, SCell, it may be determined that the channel is busy or idle. If the channel is determined to be idle, an eNB may start signal transmission in the SCell. This procedure may be referred to as LBT.

FIG. 7 is a view illustrating an exemplary Frame Based Equipment (FBE) operation as one of LBT operations.

The European Telecommunication Standards Institute (ETSI) regulation (EN 301 893 V1.7.1) defines two LBT operations, Frame Based Equipment (FBE) and Load Based Equipment (LBE). In FBE, one fixed frame is comprised of a channel occupancy time (e.g., 1 to 10 ms) being a time period during which a communication node succeeding in channel access may continue transmission, and an idle period being at least 5% of the channel occupancy time, and CCA is defined as an operation for monitoring a channel during a CCA slot (at least 20 μs) at the end of the idle period.

A communication node periodically performs CCA on a per-fixed frame basis. If the channel is unoccupied, the communication node transmits data during the channel occupancy time. On the contrary, if the channel is occupied, the communication node defers the transmission and waits until the CCA slot of the next period.

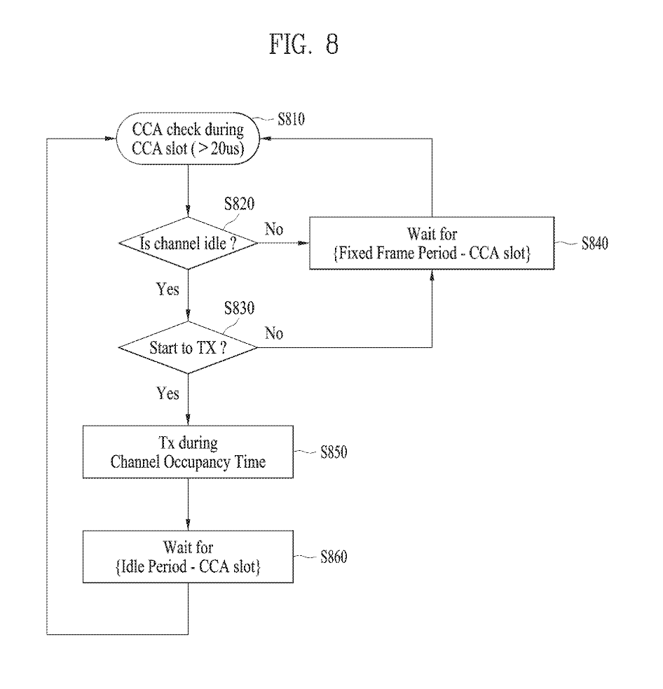

FIG. 8 is a block diagram illustrating the FBE operation.

Referring to FIG. 8, a communication node (i.e., eNB) managing an SCell performs CCA during a CCA slot [S810]. If the channel is idle [S820], the communication node performs data transmission (Tx) [S830]. If the channel is busy, the communication node waits for a time period calculated by subtracting the CCA slot from a fixed frame period, and then resumes CCA [S840].

The communication node transmits data during the channel occupancy time [S850]. Upon completion of the data transmission, the communication node waits for a time period calculated by subtracting the CCA slot from the idle period [S860], and then resumes CCA [S810]. If the channel is idle but the communication node has no transmission data, the communication node waits for the time period calculated by subtracting the CCA slot from the fixed frame period [S840], and then resumes CCA [S810].

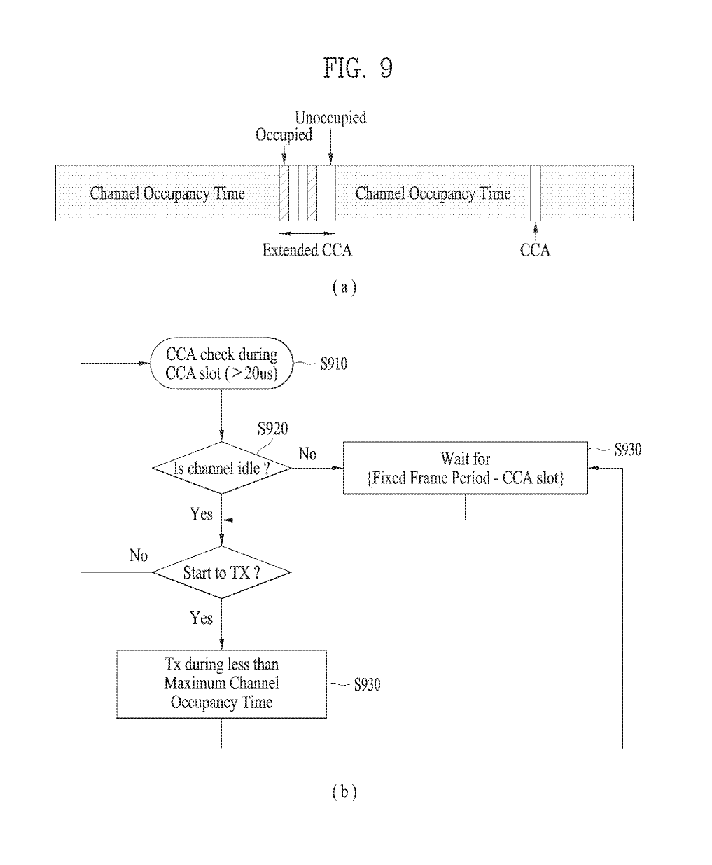

FIG. 9 is a view illustrating an exemplary LBE operation as one of the LBT operations.

Referring to FIG. 9(a), in LBE, the communication node first sets q (q∈{4, 5, . . . , 32}) and then performs CCA during one CCA slot.

FIG. 9(b) is a block diagram illustrating the LBE operation. The LBE operation will be described with reference to FIG. 9(b).

The communication node may perform CCA during a CCA slot [S910]. If the channel is unoccupied in a first CCA slot [S920], the communication node may transmit data by securing a time period of up to (13/32)q ms [S930].

On the contrary, if the channel is occupied in the first CCA slot, the communication node selects N (N∈{1, 2, . . . , q}) arbitrarily (i.e., randomly) and stores the selected N value as an initial count. Then, the communication node senses a channel state on a CCA slot basis. Each time the channel is unoccupied in one specific CCA slot, the communication node decrements the count by 1. If the count is 0, the communication node may transmit data by securing a time period of up to (13/32)q ms [S940].

2.3 Discontinuous Transmission in DL

When discontinuous transmission is performed on an unlicensed carrier having a limited maximum transmission period, the discontinuous transmission may influence on several functions necessary for performing an operation of LTE system. The several functions can be supported by one or more signals transmitted at a starting part of discontinuous LAA DL transmission. The functions supported by the signals include such a function as AGC configuration, channel reservation, and the like.

When a signal is transmitted by an LAA node, channel reservation has a meaning of transmitting signals via channels, which are occupied to transmit a signal to other nodes, after channel access is performed via a successful LBT operation.

The functions, which are supported by one or more signals necessary for performing an LAA operation including discontinuous DL transmission, include a function for detecting LAA DL transmission transmitted by a UE and a function for synchronizing frequency and time. In this case, the requirement of the functions does not mean that other available functions are excluded. The functions can be supported by other methods.

2.3.1 Time and Frequency Synchronization

A design target recommended by LAA system is to support a UE to make the UE obtain time and frequency synchronization via a discovery signal for measuring RRM (radio resource management) and each of reference signals included in DL transmission bursts, or a combination thereof. The discovery signal for measuring RRM transmitted from a serving cell can be used for obtaining coarse time or frequency synchronization.

2.3.2 DL Transmission Timing

When a DL LAA is designed, it may follow a CA timing relation between serving cells combined by CA, which is defined in LTE-A system (Rel-12 or earlier), for subframe boundary adjustment. Yet, it does not mean that a base station starts DL transmission only at a subframe boundary. Although all OFDM symbols are unavailable in a subframe, LAA system can support PDSCH transmission according to a result of an LBT operation. In this case, it is required to support transmission of control information necessary for performing the PDSCH transmission.

2.4 Measuring and Reporting RRM

LTE-A system can transmit a discovery signal at a start point for supporting RRM functions including a function for detecting a cell. In this case, the discovery signal can be referred to as a discovery reference signal (DRS). In order to support the RRM functions for LAA, the discovery signal of the LTE-A system and transmission/reception functions of the discovery signal can be applied in a manner of being changed.

2.4.1 Discovery Reference Signal (DRS)

A DRS of LTE-A system is designed to support on/off operations of a small cell. In this case, off small cells correspond to a state that most of functions are turned off except a periodic transmission of a DRS. DRSs are transmitted at a DRS transmission occasion with a period of 40, 80, or 160 ms. A DMTC (discovery measurement timing configuration) corresponds to a time period capable of anticipating a DRS received by a UE. The DRS transmission occasion may occur at any point in the DMTC. A UE can anticipate that a DRS is continuously transmitted from a cell allocated to the UE with a corresponding interval.

If a DRS of LTE-A system is used in LAA system, it may bring new constraints. For example, although transmission of a DRS such as a very short control transmission without LBT can be permitted in several regions, a short control transmission without LBT is not permitted in other several regions. Hence, a DRS transmission in the LAA system may become a target of LBT.

When a DRS is transmitted, if LBT is applied to the DRS, similar to a DRS transmitted in LTE-A system, the DRS may not be transmitted by a periodic scheme. In particular, it may consider two schemes described in the following to transmit a DRS in the LAA system.

As a first scheme, a DRS is transmitted at a fixed position only in a DMTC configured on the basis of a condition of LBT.

As a second scheme, a DRS transmission is permitted at one or more different time positions in a DMTC configured on the basis of a condition of LBT.

As a different aspect of the second scheme, the number of time positions can be restricted to one time position in a subframe. If it is more profitable, DRS transmission can be permitted at the outside of a configured DMTC as well as DRS transmission performed in the DMTC.

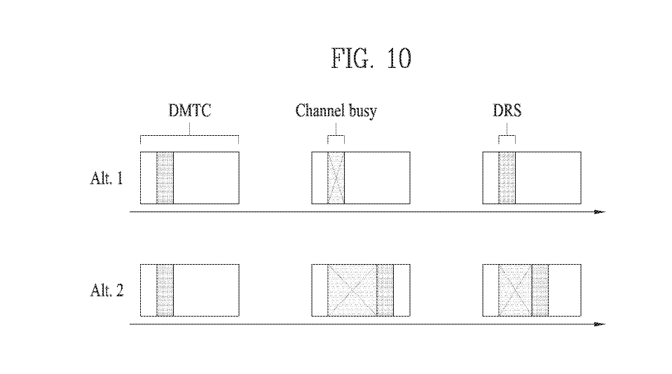

FIG. 10 is a diagram for explaining DRS transmission methods supported by LAA system.

Referring to FIG. 10, the upper part of FIG. 10 shows the aforementioned first scheme for transmitting a DRS and the bottom part of FIG. 10 shows the aforementioned second scheme for transmitting a DRS. In particular, in case of the first scheme, a UE can receive a DRS at a position determined in a DMTC period only. On the contrary, in case of the second scheme, a UE can receive a DRS at a random position in a DMTC period.

In LTE-A system, when a UE performs RRM measurement based on DRS transmission, the UE can perform single RRM measurement based on a plurality of DRS occasions. In case of using a DRS in LAA system, due to the constraint of LBT, it is difficult to guarantee that the DRS is transmitted at a specific position. Even though a DRS is not actually transmitted from a base station, if a UE assumes that the DRS exists, quality of an RRM measurement result reported by the UE can be deteriorated. Hence, when LAA DRS is designed, it is necessary to permit the existence of a DRS to be detected in a single DRS occasion. By doing so, it may be able to make the UE combine the existence of the DRS with RRM measurement, which is performed on successfully detected DRS occasions only.

Signals including a DRS do not guarantee DRS transmissions adjacent in time. In particular, if there is no data transmission in subframes accompanied with a DRS, there may exist OFDM symbols in which a physical signal is not transmitted. While operating in an unlicensed band, other nodes may sense that a corresponding channel is in an idle state during a silence period between DRS transmissions. In order to avoid the abovementioned problem, it is preferable that transmission bursts including a DRS signal are configured by adjacent OFDM symbols in which several signals are transmitted.

2.5 Channel Access Procedure and Contention Window Adjustment Procedure

In the following, the aforementioned channel access procedure and the contention window adjustment procedure are explained in the aspect of a transmission node.

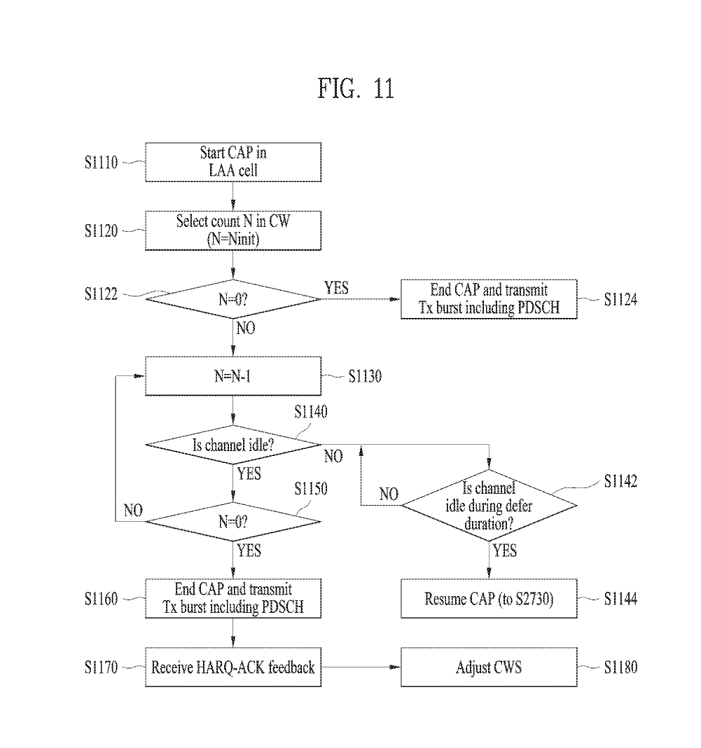

FIG. 11 is a flowchart for explaining CAP and CWA.

In order for an LTE transmission node (e.g., a base station) to operate in LAA Scell(s) corresponding to an unlicensed band cell for DL transmission, it may initiate a channel access procedure (CAP) [S1110].

The base station can randomly select a back-off counter N from a contention window (CW). In this case, the N is configured by an initial value Ninit [S1120]. The Ninit is randomly selected from among values ranging from 0 to CWₚ.

Subsequently, if the back-off counter value (N) corresponds to 0 [S1122], the base station terminates the CAP and performs Tx burst transmission including PSCH [S1124]. On the contrary, if the back-off value is not 0, the base station reduces the back-off counter value by 1 [S1130].

The base station checks whether or not a channel of the LAA Scell(s) is in an idle state [S1140]. If the channel is in the idle state, the base station checks whether or not the back-off value corresponds to 0 [S1150]. The base station repeatedly checks whether or not the channel is in the idle state until the back-off value becomes 0 while reducing the back-off counter value by 1.

In the step S1140, if the channel is not in the idle state i.e., if the channel is in a busy state, the base station checks whether or not the channel is in the idle state during a defer duration (more than 15 usec) longer than a slot duration (e.g., 9 usec) [S1142]. If the channel is in the idle state during the defer duration, the base station can resume the CAP [S1144]. For example, when the back-off counter value Ninit corresponds to 10, if the channel state is determined as busy after the back-off counter value is reduced to 5, the base station senses the channel during the defer duration and determines whether or not the channel is in the idle state. In this case, if the channel is in the idle state during the defer duration, the base station performs the CAP again from the back-off counter value 5 (or, from the back-off counter value 4 by reducing the value by 1) rather than configures the back-off counter value Ninit. On the contrary, if the channel is in the busy state during the defer duration, the base station performs the step S1142 again to check whether or not the channel is in the idle state during a new defer duration.

Referring back to FIG. 11, the base station checks whether or not the back-off counter value (N) becomes 0 [S1150]. If the back-off counter value (N) becomes 0, the base station terminates the CAP and may be able to transmit a Tx burst including PDSCH.

The base station can receive HARQ-ACK information from a UE in response to the Tx burst [S1170]. The base station can adjust a CWS (contention window size) based on the HARQ-ACK information received from the UE [S1180].

In the step S1180, as a method of adjusting the CWS, the base station can adjust the CWS based on HARQ-ACK information on a first subframe of a most recently transmitted Tx burst (i.e., a start subframe of the Tx burst).

In this case, the base station can set an initial CW to each priority class before the CWP is performed. Subsequently, if a probability that HARQ-ACK values corresponding to PDSCH transmitted in a reference subframe are determined as NACK is equal to or greater than 80%, the base station increases CW values set to each priority class to a next higher priority.

In the step S1160, PDSCH can be assigned by a self-carrier scheduling scheme or a cross-carrier scheduling scheme. If the PDSCH is assigned by the self-carrier scheduling scheme, the base station counts DTX, NACK/DTX, or ANY state among the HARQ-ACK information fed back by the UE as NACK. If the PDSCH is assigned by the cross-carrier scheduling scheme, the base station counts the NACK/DTX and the ANY states as NACK and does not count the DTX state as NACK among the HARQ-ACK information fed back by the UE.

If bundling is performed over M (M>=2) number of subframes and bundled HARQ-ACK information is received, the base station may consider the bundled HARQ-ACK information as M number of HARQ-ACK responses. In this case, it is preferable that a reference subframe is included in the M number of bundled subframes.

3. Proposed Embodiment

When a base station or a UE performs LBT (listen-before-talk)-based signal transmission in a wireless communication system consisting of the base station and the UE, the present invention proposes a detail downlink transmission method.

According to the present invention, a base station or a UE should perform LBT to transmit a signal on an unlicensed band. When the base station or the UE transmits a signal, it is necessary to make signal interference not to be occurred with different communication nodes such as Wi-Fi, and the like. For example, according to Wi-Fi standard, a CCA threshold value is regulated by −62 dBm and −82 dBm for a non-Wi-Fi signal and a Wi-Fi signal, respectively. In particular, if an STA (station) or an AP (access point) senses a signal received with power (or energy) equal to or greater than −62 dBm rather than Wi-Fi, the STA or the AP does not perform signal transmission.

In this case, it may be difficult to always guarantee DL transmission of an eNB or UL transmission of a UE on an unlicensed. Hence, a UE operating on the unlicensed band may maintain access with a different cell operating on a licensed band to stably control mobility, RRM (radio resource management) function, and the like. In the present invention, for clarity, a cell accessed by a UE on the unlicensed band is referred to as a U-Scell (or LAA Scell) and a cell accessed by the UE on the licensed band is referred to as a Pcell. As mentioned in the foregoing description, a scheme of performing data transmission/reception on the unlicensed band using a combination with the licensed band is generally called LAA (licensed assisted access).

TABLE 2

| Channel Access | | | | | allowed |
|---|---|---|---|---|---|
| Priority Class (p) | mₚ | CW_{min, p} | CW_{max, p} | T_{mcot, p} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, |
| | | | | 10 ms | 127, 255, 511, |
| | | | | | 1023} |

As shown in Table 2, in Rel-13 LAA system, 4 channel access priority classes are defined in total. And, a length of a defer period, a CWS, MCOT (maximum channel occupancy time), and the like are defined according to each of the channel access priority classes. Hence, when an eNB transmits a downlink signal via an unlicensed band, the eNB performs random backoff by utilizing LBT parameters determined according to a channel access priority class and may be then able to access a channel during limited maximum transmission time only after the random backoff is completed.

For example, in case of the channel access priority class 1/2/3/4, the maximum channel occupancy time (MCOT) is determined by 2/3/8/8 ms. The maximum channel occupancy time (MCOT) is determined by 2/3/10/10 ms in environment where other RAT such as Wi-Fi does not exists (e.g., by level of regulation).

As shown in Table 2, a set of CWSs capable of being configured according to a class is defined. One of points different from Wi-Fi system is in that a different backoff counter value is not defined according to a channel access priority class and LBT is performed using a single backoff counter value (this is referred to as single engine LBT).

For example, when an eNB intends to access a channel via an LBT operation of class 3, since CWmin (=15) is configured as an initial CWS, the eNB performs random backoff by randomly selecting an integer from among numbers ranging from 0 to 15. If a backoff counter value becomes 0, the eNB starts DL Tx and randomly selects a new backoff counter for a next Tx burst after the DL Tx burst is completed. In this case, if an event for increasing a CWS is triggered, the eNB increases a size of the CWS to 31 corresponding to a next size, randomly selects an integer from among numbers ranging from 0 to 31, and performs random backoff.

In this case, when a CWS of the class 3 is increased, CWSs of all classes are increased as well. In particular, if the CW of the class 3 becomes 31, a CWS of a class 1/2/4 becomes 7/15/31. If an event for decreasing a CWS is triggered, CWS values of all classes are initialized by CWmin irrespective of a CWS value of the triggering timing.

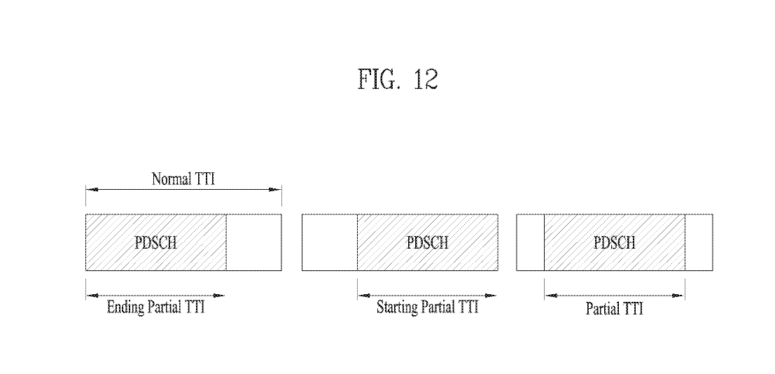

FIG. 12 is a diagram illustrating a partial TTI or a partial subframe applicable to the present invention.

In Rel-13 LAA system, MCOT is utilized as much as possible when DL Tx burst is transmitted. In order to support consecutive transmission, a partial TTI, which is defined as DwPTS, is introduced. The partial TTI (or partial subframe) corresponds to a section in which a signal is transmitted as much as a length shorter than a legacy TTI (e.g., 1 ms) when PDSCH is transmitted.

In the present invention, for clarity, a starting partial TTI or a starting partial subframe corresponds to a form that a part of symbols positioned at the fore part of a subframe are emptied out. An ending partial TTI or an ending partial subframe corresponds to a form that a part of symbols positioned at the rear part of a subframe are emptied out. (On the contrary, an intact TTI is referred to as a normal TTI or a full TTI.)

FIG. 12 illustrates various types of the aforementioned partial TTI. The first drawing of FIG. 12 illustrates an ending partial TTI (or subframe) and the second drawing illustrates a starting partial TTI (or subframe). The third drawing of FIG. 12 illustrates a partial TTI (or subframe) that a part of symbols positioned at the fore part and the rear part of a subframe are emptied out. In this case, when signal transmission is excluded from a normal TTI, a time section during which the signal transmission is excluded is referred to as a transmission gap (TX gap).

Although the present invention is explained on the basis of a DL operation in FIG. 12, the present invention can also be identically applied to a UL operation. For example, a partial TTI structure shown in FIG. 12 can be applied to a form of transmitting PUCCH or PUSCH as well.

In the following, a method of transmitting uplink control information (UCI) including HARQ-ACK and/or CSI (Channel State Information) (e.g., RI (Rank Indicator), PMI (Precoding Matric Indicator), CQI (Channel Quality Indicator), BI (Beam Index), etc.) in a CA (Carrier Aggregation) situation including a carrier(s) of an unlicensed band proposed by the present invention is explained in detail based on the aforementioned contents.

Operations of a legacy LTE system are explained in the following before the present invention is explained in detail.

In a CA situation of a legacy LTE system, if simultaneous transmission of PUCCH and PUSCH is not set to a UE or the UE is unable to perform the simultaneous transmission of PUCCH and PUSCH, the UE transmits UCI in an n^{th} subframe (SF #n) using methods described in the following.
If there is no PUSCH to be transmitted, the UE transmits UCI via PUCCH.
If there is PUSCH of which aperiodic CSI transmission is triggered, the UE transmits UCI by piggybacking the UCI via PUSCH on a corresponding cell.
When periodic CSI and/or HARQ-ACK are transmitted, if PUSCH on a primary cell (Pcell) is scheduled, the UE transmits UCI by piggybacking the UCI via the PUSCH on the Pcell (in this case, the UE does not transmit UCI on PUSCH transmitted by a random access procedure).
When periodic CSI and/or HARQ-ACK are transmitted, if PUSCH on a Pcell is not scheduled and PUSCH on a secondary cell (Scell(s)) is scheduled only, the UE transmits UCI by piggybacking the UCI via the PUSCH on the Scell to which the smallest S cell index is set.

And, in Release-14 LAA system to which the present invention is applicable, contents described in the following have been discussed.
It is unable to transmit HARQ-ACK for a licensed band (or, L-cell (licensed cell)) via an unlicensed band (or U-cell (unlicensed cell)).
HARQ-ACK for an unlicensed band and CSI can be transmitted on an unlicensed band.

The present invention proposes a method for a UE to transmit or piggyback UCI according to a HARQ-ACK codebook configuration method for UCI to be transmitted in an SF #n in consideration of the aforementioned contents.

3.1 Method 1 [HARQ-ACK Piggybacked by PUSCH of Unlicensed Band Allows HARQ-ACK for Unlicensed Band Only]

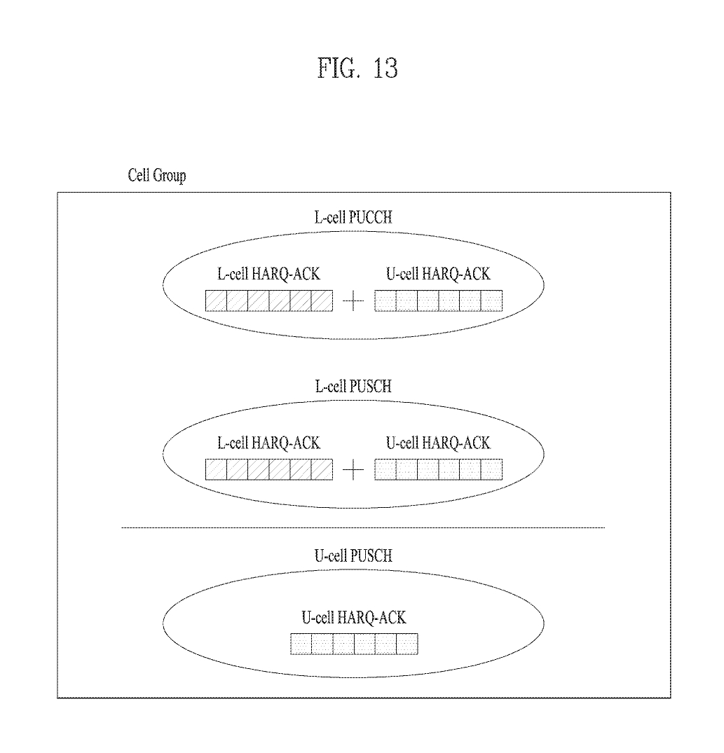

FIG. 13 is a diagram briefly illustrating a method of transmitting UCI according to the first method of the present invention.

According to the method 1 of the present invention, when CA is performed on a licensed band and an unlicensed band, as shown in FIG. 13, a UE configures a codebook of HARQ-ACK transmitted via PUCCH or PUSCH on a licensed band to be identical with a codebook of a legacy LTE system (e.g., HARQ-ACK information corresponding to the entire cells set to the UE via CA). In this case, the present invention proposes a method of configuring a codebook of HARQ-ACK transmitted via PUSCH on an unlicensed band by HARQ-ACK for an unlicensed band only (e.g., a codebook is configured by HARQ-ACK information corresponding to an unlicensed band except a licensed band among the entire cells set to a UE via CA). In other word, when HARQ-ACK information is transmitted on an unlicensed band, if there is HARQ-ACK for an unlicensed band(s) only (when simultaneous transmission of PUCCH and PUSCH is not configured), a UE can transmit HARQ-ACK codebook for the unlicensed band(s) only.

FIG. 13 illustrates all transmission options capable of being applied by a UCI transmission method according to the method 1. A UE according to the present invention can transmit UCI according to one selected from among the transmission options shown in FIG. 13.

In the following, when simultaneous transmission of PUCCH and PUSCH is not set to a UE or the UE is unable to perform simultaneous transmission of PUCCH and PUSCH, a method for the UE to transmit UCI in an SF #n according to a cell(s) to which PUSCH is scheduled is explained in detail according to the method 1 of the present invention.

3.1.1. Case 1 [when Unlicensed Band(s) PUSCH is Scheduled Only]

As an example applicable to the present invention, when HARQ-ACK for a licensed band(s) exists, if unlicensed band(s) PUSCH is scheduled only, since a UE transmits HARQ-ACK information on an unlicensed band, the UE may not expect unlicensed band PUSCH scheduling. However, if the UE fails to receive a scheduling grant for licensed band(s) PUSCH or misses the scheduling grant for licensed band(s) PUSCH, the UE does not attempt to transmit the unlicensed band(s) PUSCH (or does not perform LBT on the PUSCH transmission) and may be able to transmit UCI via PUCCH on a licensed band.

As a different example applicable to the present invention, when (a)periodic CSI for licensed band(s) exists without HARQ-ACK information, if unlicensed band(s) PUSCH is scheduled only, since a UE transmits CSI information on an unlicensed band, the UE may not expect unlicensed band PUSCH scheduling. However, if the UE fails to receive a scheduling grant for licensed band(s) PUSCH or misses the scheduling grant for licensed band(s) PUSCH, the UE does not attempt to transmit the unlicensed band(s) PUSCH (or does not perform LBT on the PUSCH transmission) and may be able to transmit UCI via PUCCH on a licensed band. Or, the UE drops (a)periodic CSI information on a licensed band(s) and may be then able to attempt to transmit unlicensed band(s) PUSCH.

As a further different example applicable to the present invention, when HARQ-ACK for an unlicensed band(s) exists only, a UE according to the present invention can be configured to transmit UCI on an unlicensed band having the smallest Scell index among scheduled cells. Or, although HARQ-ACK for an unlicensed band(s) exists only, the UE may not attempt to perform unlicensed band(s) PUSCH transmission (or does not perform LBT on the PUSCH transmission) and may be able to transmit UCI via PUCCH on a licensed band. In this case, the UE may not expect aperiodic CSI reporting via unlicensed band PUSCH at the timing identical to the timing of HARQ-ACK transmission subframe.

3.1.2 Case 2 [when Licensed Band(s) PUSCH as Well as Unlicensed Band(s) PUSCH are Scheduled]

When HARQ-ACK for a licensed band(s) exists and Pcell PUSCH is not scheduled, according to a legacy method, a UE transmits UCI information by piggybacking the UCI information via Scell PUSCH having the smallest Scell index. However, if the Scell having the smallest Scell index is on an unlicensed band, since licensed band(s) HARQ-ACK is transmitted on an unlicensed band, it is not preferable.

Hence, as an example applicable to the present invention, a UE can be configured to transmit UCI on a Scell having the smallest Scell index among scheduling licensed bands. Or, it may set a limit on an eNB to make the eNB schedule a Scell having the smallest Scell index to be a licensed band among Scells scheduled at an SF #n. In other word, among the Scells scheduled at the SF #n, the UE may not expect that the Scell having the smallest Scell index is to be scheduled as an unlicensed band.

Or, when HARQ-ACK for an unlicensed band(s) as well as HARQ-ACK for a licensed band(s) exist and an Scell having the smallest Scell index corresponds to an unlicensed band, a UE according to the present invention can be configured to transmit HARQ-ACK information on an unlicensed band(s) by piggybacking the HARQ-ACK information on an unlicensed band PUSCH and transmit HARQ-ACK information on a licensed band(s) by piggybacking the HARQ-ACK information on a licensed PUSCH having the smallest Scell index among scheduled licensed bands.

When HARQ-ACK for a licensed band(s) exists and aperiodic CSI transmission is triggered on an unlicensed band PUSCH, according to a legacy operation, a UE should transmit the HARQ-ACK for the licensed band(s) on the unlicensed band PUSCH. In this case, as a different example applicable to the present invention, a UE may not expect the aperiodic CSI transmission triggering. Or, the UE may transmit aperiodic CSI on an unlicensed band PUSCH where the aperiodic CSI transmission is triggered and transmit HARQ-ACK information by piggybacking the HARQ-ACK information via a Pcell of PUSCH on a licensed band having the smallest Scell index among scheduled licensed bands.

As a further different example applicable to the present invention, when HARQ-ACK for an unlicensed band(s) exists only, a UE can be configured to transmit UCI on a Scell having the smallest Scell index among scheduled cells.

As a further different example applicable to the present invention, when (a)periodic CSI on a licensed band(s) exists without HARQ-ACK information, a UE may not expect PUSCH scheduling that the CSI information is transmitted on an unlicensed band. In other word, the UE according to the present invention may not expect a case of triggering aperiodic CSI transmission via an unlicensed band PUSCH and a case that a Scell having the smallest Scell index corresponds to an unlicensed band. Or, the UE may drop transmission of (a)periodic CSI information on a licensed band(s) and attempt to transmit unlicensed band(s) PUSCH.

3.1.3. Case 3 [when a Partial DL Grant is not Receive or Missed]

Release-13 LTE system considers carrier aggregation (CA) including 5 or more component carriers (CCs). In this case, if a UE receives PDSCH at the same time on a plurality of CCs and transmits HARQ-ACK in response to the PDSCH, the UE may fail to receive a DL grant or miss the DL grant for a partial CC. As a result, a probability of making a mismatch of a HARQ-ACK codebook size between an eNB and a UE may relatively increase (compared to a case of receiving PDSCH at the same time on the small number of CCs only).

In order to solve the mismatch problem, LTE system to which the present invention is applicable may consider a counter DAI (downlink assignment index) and the total DAI. For example, in case of a counter DAI of a size of 2 bits, a DL grant and PDSCH are received on a CC #1, a CC #2, and a CC #4 using a counter DAI ‘00’, a counter DAI ‘01’, and a counter DAI ‘10’, respectively. If the total DAIS is indicated by 3, (in case of a single codeword) a UE can configure and transmit a HARQ-ACK codebook of the total 3 bits for the CC #1, the CC #2, and the CC #4. If a DL grant and PDSCH are received on a CC #1, a CC #2, and a CC #4 using a counter DAI ‘00’, a counter DAI ‘01’, and a counter DAI ‘10’, respectively, and the total DAIs is indicated by 4, a UE recognizes that the UE has failed to receive a DL grant and PDSCH corresponding to a counter DAI ‘10’ and may be able to configure and transmit a HARQ-ACK codebook of the total 4 bits (HARQ-ACK for the CC #1, HARQ-ACK for the CC #2, DTX, and HARQ-ACK for the CC #4). In particular, the UE is able to recognize that the UE has failed to receive a partial DL grant and PDSCH or the UE has missed a partial DL grant and PDSCH in consideration of a counter DAI and the total DAI.

In the aspect of a UE applicable to the present invention, if HARQ-ACK for an unlicensed band(s) exists only at the timing of SF #n and a cell scheduled at the timing of SF #n corresponds to an unlicensed band(s) only except missed DL reception, the UE may operate as follows.

For example, similar to the example of the case 1, UCI can be configured to be transmitted on a Scell having the smallest Scell index among scheduled cells or all scheduled unlicensed bands.

As a different example, if reception of a DL grant or PDSCH is missed, since the missed DL grant may correspond to a DL grant for a licensed band(s), it may consider a method of more reliably transmitting HARQ-ACK. To this end, if reception of the DL grant or PDSCH is missed, a UE according to the present invention can be configured to always drop unlicensed band(s) PUSCH and transmit HARQ-ACK via PUCCH.

As a further different example, if reception of a DL grant or PDSCH is missed, the UE according to the present invention is configured to always drop unlicensed band(s) PUSCH and transmit HARQ-ACK via PUCCH only when missing of the DL grant for the licensed band(s) is certain. When missing of the DL grant for the licensed band(s) is not certain, the UE according to the present invention can be configured to transmit UCI via a Scell having the smallest Scell index among scheduled cells or transmit UCI via all scheduled unlicensed bands. In this case, if it is determined that missing of the DL grant for the licensed band(s) is certain, it means that at least one of conditions described in the following is satisfied. Each of the conditions is explained in detail with reference to Table 3 in the following.

TABLE 3

| CC index | Counter DAI | Total DAI |
|---|---|---|
| 1 (L- cell) | | |
| 2 (U- cell) | 01 | 01 |
| | (00→ missed) | |
| 3 (L- cell) | | |
| 4 (U- cell) | 11 | 01 |
| | (10→ missed) | |
| 5 (L- cell) | (00, 01 → missed) | |
| 6 (U- cell) | | |
| 7 (L- cell) | | |

1) First condition: when a UE misses the first n number of DL grants and a CC index at which PDSCH is received with (n+1)^{th} counter DAI corresponds to k (for clarity, assume that CC indexes start from 1), if the number of unlicensed bands is less than n among the (k−1) number of CCs having a CC index smaller than a CC index of the corresponding CC.

According to the example of Table 3, although a UE receives a DL grant on an unlicensed band corresponding to a CC index #2, since a counter DAI value corresponds to ‘01’, it is able to determine that the UE has missed a DL grant corresponding to ‘00’. In this case, since a CC index #1 corresponds to a licensed band, it is able to know that the UE has missed a DL grant for a licensed band.

2) Second condition: When a UE receives a counter DAI value X+n after a counter DAI value X (i.e., when the UE misses a DL grant corresponding to counter DAI X+1, . . . , X+n−1), if unlicensed bands less than the n number of unlicensed bands exist between a DL CC index K corresponding to the counter DAI value X and a DL CC index K′ corresponding to the counter DAI value X+n

According to the example of Table 3, when the UE receives a counter DAI ‘01’ and a counter DAI ‘11’, if the UE misses a DL grant corresponding to a counter DAI ‘10’ corresponding to a value between the counter DAI ‘01’ and the counter DAI ‘11’, since a single licensed band exists between a CC index #2 and a CC index #4, the UE is able to make sure that a DL grant for a licensed band is missed.

3) Third condition: When total DAI value is signaled by X and the last counter DAI value among actually received DL grants corresponds to X−n, if unlicensed bands less than the n number of unlicensed bands exist among CC indexes having a CC index greater than a CC index k corresponding to the counter DAI value X−n

According to the example of Table 3, when total DAI value received by a UE corresponds to ‘01’ and a counter DAI value corresponds to ‘11’, it is able to know that the UE has missed a DL grant corresponding to a counter DAI value ‘00’ and a DL grant corresponding to a counter DAI value ‘01’. In this case, although there are 3 CCs having an index greater than a CC index #4, there is one unlicensed band only among the 3 CCs. Hence, the UE is able to determine that a DL grant for at least one licensed band has been missed.

4) Fourth condition: When total DAI value is greater than the number of configured unlicensed bands

In this case, although each of the conditions mainly considers a case of HARQ-ACK corresponding to a single subframe only, each of the conditions applicable to the present invention can be easily applied to a case of HARQ-ACK transmission corresponding to a plurality of subframes on a time axis.

3.2. Method 2 [HARQ-ACK Piggybacked by Unlicensed Band PUSCH Allows HARQ-ACK for an Unlicensed Band Only and HARQ-ACK Piggybacked by Licensed Band PUSCH Allows HARQ-ACK for a Licensed Band Only]

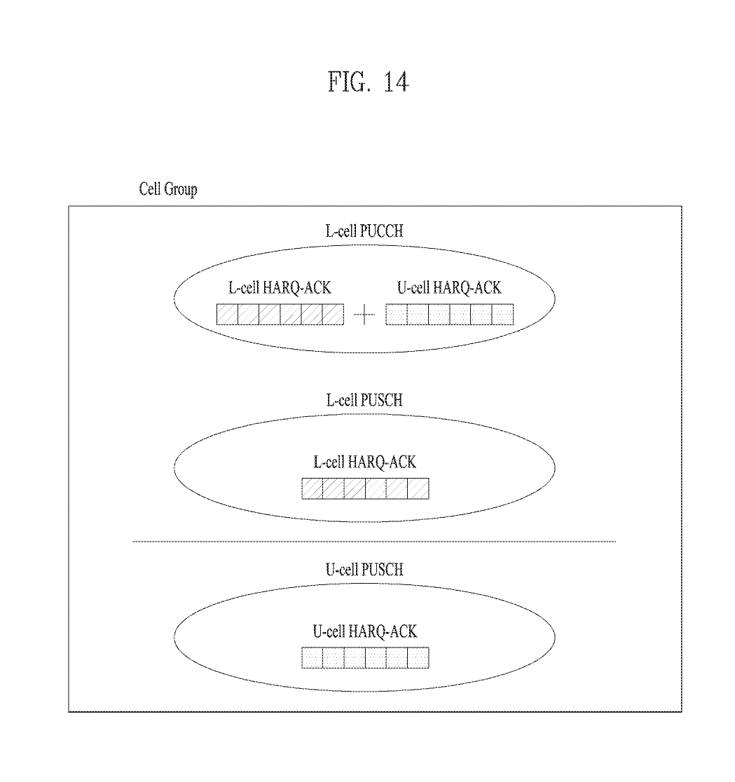

FIG. 14 is a diagram briefly illustrating a method of transmitting UCI according to the second method of the present invention.

The method 2 of the present invention, as shown in FIG. 14, proposes a method for a UE to transmit HARQ-ACK in a CA situation of a licensed band(s) and an unlicensed band(s). Unlike the aforementioned method 1, according to the method 2 of the present invention, a codebook of HARQ-ACK transmitted via PUSCH of a licensed band is configured by licensed band HARQ-ACK only.

More specifically, when simultaneous transmission of PUCCH and PUSCH is not configured or a UE is unable to simultaneously transmit PUCCH and PUSCH, the UE is able to transmit UCI as follows depending on a cell(s) to which PUSCH is scheduled in an SF #n according to the method 2 of the present invention.

3.2.1. Case 1 [when Unlicensed Band(s) PUSCH is Scheduled Only]

When HARQ-ACK for a licensed band(s) exists, since it is necessary for a UE to transmit HARQ-ACK information on an unlicensed band, the UE may not expect PUSCH scheduling. However, since the UE may miss a scheduling grant for licensed band(s) PUSCH, the UE can transmit UCI via PUCCH on a licensed band without attempting to transmit unlicensed band(s) PUSCH (or without performing LBT on PUSCH transmission).

3.2.2. Case 2 [when Licensed Band(s) PUSCH is Scheduled Only]

When HARQ-ACK for a licensed band(s) exists, a UE can be configured to transmit UCI by piggybacking the UCI on a scheduled licensed band(s) PUSCH while not transmitting HARQ-ACK for an unlicensed band(s). Or, the UE may not transmit licensed band(s) PUSCH. Instead, the UE can be configured to transmit HARQ-ACK for an unlicensed band(s) via a licensed band PUCCH.

3.3. Method 3 [HARQ-ACK Piggybacked by Unlicensed Band PUSCH Allows HARQ-ACK for an Unlicensed Band Only and HARQ-ACK Piggybacked by Licensed Band PUCCH and PUSCH Allows HARQ-ACK for a Licensed Band Only]

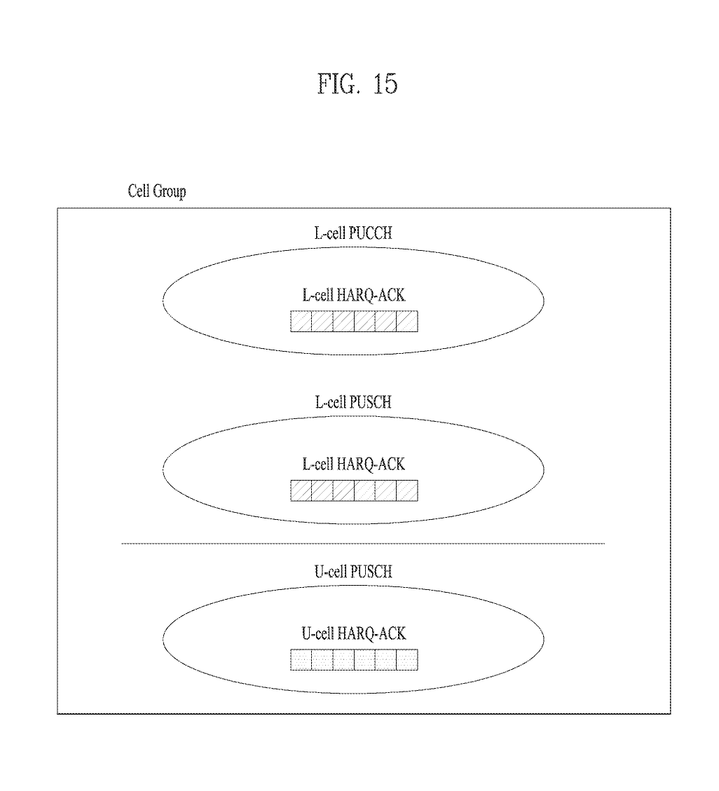

FIG. 15 is a diagram briefly illustrating a method of transmitting UCI according to the third method of the present invention.

The method 3 of the present invention, as shown in FIG. 15, proposes a method for a UE to transmit HARQ-ACK in a CA situation of a licensed band(s) and an unlicensed band(s). Unlike the aforementioned method 2, according to the method 3 of the present invention, a codebook of HARQ-ACK transmitted via PUCCH of a licensed band is configured by licensed band HARQ-ACK only.

3.3.1. First Example for the Method 3

According to a general UE implementation method, a licensed band and an unlicensed band are transmitted using a different RF (Radio Frequency) module. In this case, when a UE transmits PUCCH and/or PUSCH in each cell, it can be configured as a mandatory feature of the UE. In other word, although it is able to configure whether or not PUCCH and PUSCH are simultaneously transmitted on licensed bands in a manner of being similar to a legacy LTE system, simultaneous transmission of a licensed band PUCCH and an unlicensed band PUSCH can be configured as a mandatory thing. This method can also be applied to the aforementioned method 1 and the method 2.

However, if it is not realistically easy to provide degree of freedom to configurability of a network and make a specific implementation of a UE to be mandatory, simultaneous transmission of a licensed band PUCCH and an unlicensed band PUSCH may not be configured as a mandatory feature. On the other hand, when a licensed band and an unlicensed band are transmitted, since the bands are transmitted using a different RF module in general, transmission capability capable of simultaneously transmitting a licensed band PUCCH and an unlicensed band PUSCH and transmission capability capable of simultaneously transmitting a licensed band PUCCH and a licensed band PUSCH can be individually signaled (although a licensed band and an unlicensed band belong to a single PUCCH cell group).

If simultaneous transmission of licensed band PUCCH and unlicensed band PUSCH corresponds to configuration rather than compulsory, as mentioned in the method 3, it is able to separate a HARQ-ACK codebook transmitted on a licensed band from a HARQ-ACK codebook transmitted on an unlicensed band only when the simultaneous transmission of licensed band PUCCH and unlicensed band PUSCH is configured. This is because, if the method 3 is allowed to be applied to case that the simultaneous transmission of licensed band PUCCH and unlicensed band PUSCH is not configured, since it is able to drop unlicensed band(s) PUSCH according to a specific condition (e.g., HARQ-ACK for a licensed band(s) exists and there is no scheduled licensed band(s) PUSCH), unlicensed band PUSCH transmission is inefficient.

And, HARQ-ACK for an unlicensed band(s) can be transmitted on an unlicensed band only. In this case, if unlicensed band PUSCH transmission including a UL-SCH (Shared Channel) is scheduled, similar to a legacy LTE system, a UE can transmit UCI by piggybacking the UCI on the PUSCH. However, if there is no UL-SCH to be transmitted by a UE, since the UE is unable to transmit HARQ-ACK for an unlicensed band(s), it is necessary to have a mechanism that allows the transmission of HARQ-ACK for the unlicensed band(s).

3.3.2. Second Example for the Method 3

If a UE is allowed to transmit PUSCH configured by UCI only without UL-SCH on an unlicensed band, a UL grant for the PUSCH, which is configured by UCI only without UL-SCH, can include at least one of information described in the following. (The characteristics of the PUSCH, which is configured by UCI only without UL-SCH, and the characteristics of the UL grant for the PUSCH can also be applied to the aforementioned method 1 and the method 2.)
MCS (Modulation and Coding Scheme) for HARQ-ACK
MCS for CSI
PUSCH transmission timing
LBT related information

The PUSCH configured by UCI only without UL-SCH can be configured by an LBT method more advantageous compared to an LBT method set to PUSCH including UL-SCH. For example, the advantageous LBT method can include an LBT method starting transmission when a channel is determined as idle after channel sensing is performed on the channel during shorter time, an LBT method of configuring a contention window size (CWS) smaller than a reference CWS, a random backoff based LBT method utilizing a fixed CWS without CWS adjustment, and an LBT method to which an energy detection threshold value higher than a reference energy detection threshold value is set. In this case, the LBT related information and/or the MCS information can be configured in advance via higher layer signaling or DCI.

The PUSCH configured by UCI only without UL-SCH can be configured by HARQ-ACK only without CSI. In this case, if PUSCH is configured by HARQ-ACK only, similar to a legacy PUSCH piggyback method, the PUSCH is sequentially mapped to REs (resource elements) near a DMRS (demodulation reference signal) and the remaining REs can be filled with zero padding or null data. In this case, a UL grant can be newly defined irrespective of a legacy PUSCH grant or can be configured by a field identical to a field of the legacy PUSCH grant. In this case, a PUSCH grant can be triggered by a combination of specific fields. For example, if an RA (Resource Allocation) field value corresponds to Q (or if a PRB size is equal to or less than R RBs) and an RV (Redundancy Version) value corresponds to M (e.g., M=3), and an MCS level value corresponds to P (P=30), it may be able to configure the PUSCH, which is configured by UCI only without UL-SCH, to be transmitted.

More specifically, if fields constructing a UL grant satisfy a part of conditions described in the following, it is able to trigger a transmission of the PUSCH configured by UCI only without UL-SCH.
When an aperiodic CSI triggering field is on
When an RA field value corresponds to Q (or when a PRB size is equal to or less than R RBs)
When an RV value corresponds to M (e.g., M=3)
When an MCS level value corresponds to P (e.g., P=30)

In this case, if the aperiodic CSI triggering field is on, a UE is configured to transmit aperiodic CSI and HARQ-ACK at the same time without UL-SCH. If the aperiodic CSI triggering field is off, the UE can be configured to transmit HARQ-ACK only without UL-SCH and aperiodic CSI.

When a UE intends to transmit HARQ-ACK for an unlicensed band(s) in a subframe, if PUSCH or the PUSCH, which is configured by UCI only without UL-SCH, is not scheduled to the subframe, the UE can be configured to drop transmission of UCI information in the subframe. This method can also be applied to a case that simultaneous transmission of PUCCH and PUSCH is not set to a UE.

3.3.3. Third Example for the Method 3

As mentioned earlier in the second example, in order for an eNB to always receive unlicensed band UCI information, the eNB should transmit a UL grant. Since the abovementioned signal configuration brings about signal overhead, the present invention proposes a method of reducing signal overhead.

To this end, (similar to a legacy PUCCH transmission), a UE receives a PUSCH resource on which UCI is piggybacked in advance via RRC signaling and the UE is able to transmit PUSCH configured by UCI only without UL-SCH via a resource indicated by utilizing an ARI (Ack/Nack Resource Indicator) value of a DL grant. In this case, PUSCH can be configured by HARQ-ACK only without CSI. In particular, if the PUSCH is configured by HARQ-ACK only, similar to a legacy PUSCH piggyback method, the PUSCH is sequentially mapped to REs near a DMRS and the remaining REs can be filled with zero padding or null data.

If PUSCH scheduled by a UL grant and PUSCH for transmitting UCI scheduled by a DL grant coexist in an SF #n, a UE selectively transmits the PUSCH scheduled by the UL grant only and the UE is able to transmit UCI by piggybacking the UCI via the PUSCH. An eNB should always reserve a PUSCH resource not including UL-SCH in preparation for a case of missing a UL grant. In order to supplement the demerit above, the eNB indicates a UE to transmit PUSCH together with UL-SCH via a specific ARI value of a DL grant. Having indicated the ARI value, the UE may expect that there is a UL grant for PUSCH to be transmitted at piggyback timing for UCI transmission.

3.3.4. Fourth Example for the Method 3

When simultaneous transmission of PUCCH and PUSCH is not set to a UE, if unlicensed band(s) PUSCH is scheduled only in an SF #n and licensed band(s) HARQ-ACK exists in the SF #n, the UE drops transmission of unlicensed band(s) PUSCH and may attempt to transmit licensed band(s) HARQ-ACK via licensed band PUCCH. Although unlicensed band(s) HARQ-ACK to be transmitted exists in the SF #n, the UE can drop the HARQ-ACK transmission. Or, the operation (when simultaneous transmission of PUCCH and PUSCH is not set to a UE, if unlicensed band(s) PUSCH is scheduled only in an SF #n and licensed band(s) HARQ-ACK exists in the SF #n) can be defined as malfunction of an eNB. In this case, the UE may not expect the operation.

3.4. Method 4 [PUCCH Transmission on Unlicensed Band is Allowed and Independent Cell Group Consisting of Unlicensed Bands is Allowed]

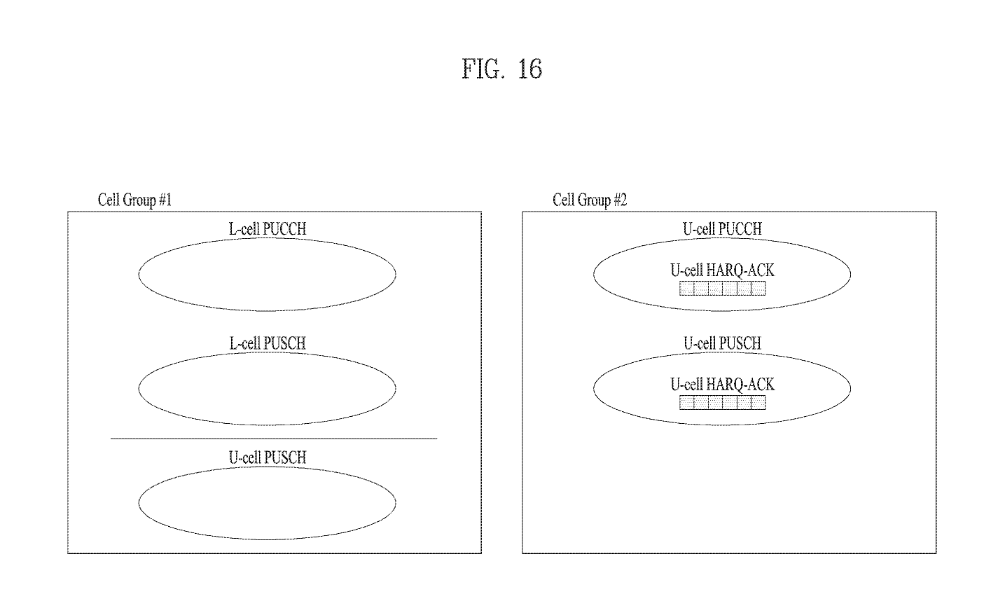

FIG. 16 is a diagram briefly illustrating a method of transmitting UCI according to the fourth method of the present invention. In this case, configurations represented in each cell group can be distinguished from each other. One or more configurations can be applied to each of the cell groups.

For example, if unlicensed band PUCCH is introduced, it may allow an independent cell group consisting of unlicensed bands only. The cell group can be configured like a cell group #2 illustrated in FIG. 16. And, since a cell group #1 including a licensed band includes an unlicensed band, the piggyback method mentioned earlier in the methods 1 to 3 can be applied to the cell group #1. Or, unlike the cell group #1, it may be able to define a rule that a cell group including a licensed band does not include a separate unlicensed band.

More specifically, if self-carrier scheduling is applied to an unlicensed band, an eNB should perform LBT to transmit a UL grant to a UE and the UE should perform LBT to perform PUSCH transmission in response to the UL grant. As a result, PUSCH transmission probability can be lowered. Hence, cross-carrier scheduling can be more importantly considered. However, since release-13 LAA system prohibits cross-carrier scheduling between unlicensed bands, cross-carrier scheduling may not be allowed to the cell group #2 shown in FIG. 16. However, in order to increase a transmission probability of LAA UL, cross-carrier scheduling for a UL grant can be allowed only between unlicensed bands or cross-carrier scheduling can be allowed between cell groups to perform cross-carrier scheduling on a licensed band.

3.5. Method 5 [Method of Transmitting UCI in U-Cell]

Unlike transmission of UCI information on a licensed band, when UCI information is transmitted on an unlicensed band, a UE may fail to transmit the UCI information on the unlicensed band due to the failure of LBT operation of the UE. For example, when aperiodic CSI transmission in an SF #n is triggered by U-cell #1, if a scheduled UE fails to perform LBT for UL transmission in the SF #n, the UE drops transmission of the aperiodic CSI and different UCI transmission. If unlicensed band transmission of the UE is not discovered in the SF #n, an eNB may not expect triggered UCI transmission.

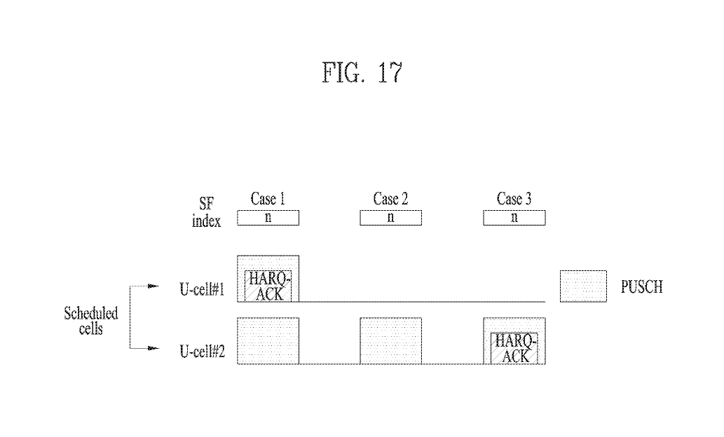

And, when periodic CSI and/or HARQ-ACK are transmitted, if a UE fails to perform LBT, it is unable to perform UL transmission. Hence, an operation of an eNB can be differentiated from a legacy operation. FIG. 17 is a diagram briefly illustrating three cases of transmitting UCI information on an unlicensed band. Specifically, as shown in FIG. 17, if <case 2> occurs among the three cases, an operation of an eNB can be differentiated.
Things common to all cases: PUSCH is scheduled to a U-cell #1 and a U-cell #2 only in an SF #n. The smallest Scell index corresponds to the U-cell #1. HARQ-ACK and/or periodic CSI to be transmitted exist in the SF #n.
Case 1: A UE successfully receives a UL grant for the U-cell #1 and a UL grant for the U-cell #2. Subsequently, the UE successfully performs LBT on the two unlicensed bands (U-cell #1 and U-cell #2) and transmits PUSCH on all unlicensed bands. In particular, the UE transmits UCI by piggybacking the UCI on the U-cell #1.
Case 2: A UE successfully receives a UL grant for the U-cell #1 and a UL grant for the U-cell #2. However, since the UE successfully performs LBT on the U-cell #2 only, the UE transmit PUSCH on the U-cell #2. In case of UCI to be transmitted on the U-cell #1, since there is no room for transmitting UCI on the U-cell #2 at the timing after the LBT failure on the U-cell #1 is determined, the UCI transmission is dropped.
Case 3: A UE successfully receives a UL grant for the U-cell #2 only. Subsequently, since the UE successfully perform LBT on the U-cell #2, the UE transmits UCI by piggybacking the UCI on PUSCH on the U-cell #2.

If a legacy eNB discovers transmission in at least one or more cells, the legacy eNB may expect UCI transmission in one of the cells. However, if there is no UCI transmission in all cells where transmission is discovered due to the aforementioned case 2, it is necessary for an eNB to perform blind detection to determine whether or not UCI is transmitted. As a result, implementation complexity of the eNB may increase. Hence, the method 5 of the present invention proposes methods described in the following to solve the problem above.

3.5.1. First Example of the Method 5 [UCI Information are Simultaneously Transmitted on all Unlicensed Bands]

If periodic CSI and/or HARQ-ACK occur on any unlicensed band, it may be able to define a rule that a UE transmits UCI by simultaneously piggybacking the UCI via all unlicensed bands attempting to perform transmission in a corresponding subframe. In other word, UCI information transmitted on all unlicensed bands attempting to perform transmission may be the same. The UCI information can include all HARQ-ACK information included in a UCI cell group consisting of unlicensed bands. In this case, the UCI cell group corresponds to a cell group configured to transmit HARQ-ACK of unlicensed bands. HARQ-ACK information on the unlicensed bands included in the UCI cell group can be transmitted via an unlicensed band belonging to the UCI cell group only. In particular, although it fails to perform LBT on a specific unlicensed band, it is able to reduce a probability of failing to transmit UCI information. And, when an eNB receives UCI information from a plurality of unlicensed bands, it may have a merit in that it is able to obtain a combining gain.

3.5.2. Second Example of the Method 5 [UCI Information Transmission Per Carrier]

It may be able to define a rule that periodic CSI and/or HARQ-ACK for U-cell #X is to be transmitted via the U-cell #X only.

3.5.3. Third Example of the Method 5 [UCI Including Periodic CSI is Transmitted Only on Unlicensed Band]

A UE transmits UCI by piggybacking the UCI in a subframe of a cell only when aperiodic CSI is triggered via an unlicensed band. When periodic CSI and/or HARQ-ACK are piggybacked via PUSCH, (although there is scheduled unlicensed band(s) PUSCH) UCI including the periodic CSI and/or the HARQ-ACK is piggybacked via PUSCH and the UCI can be transmitted via Scell having the smallest Scell index on a licensed band.

3.5.4. Fourth Example of the Method 4 [If it Fails to Perform LBT on Cell in which UCI is to be Transmitted, all Transmissions are Dropped]

Referring to an example of FIG. 17, if a UE fails to perform LBT on any unlicensed band in an SF #n and does not attempt to perform transmission, it may be able to define a rule that the UE does not attempt to perform transmission on all unlicensed bands (when there are periodic CSI and/or UCI information to be transmitted by piggybacking the periodic CSI and/or the UCI information on an unlicensed band).

3.5.5. Fifth Example of the Method 5 [UCI is Transmitted on a Specific Unlicensed Band of a Second Subframe within TX Burst]

If there is an unlicensed band on which a transmission is in progress by a UE, the UE can transmit UCI by preferentially piggybacking the UCI on a corresponding cell. For example, when a UE performs transmission via unlicensed bands, it may be able to define a rule that the UE transmit UCI information including periodic CSI and/or HARQ-ACK by piggybacking the UCI information on an unlicensed band having the smallest Scell index among the unlicensed bands.

And, when a UE intends to transmit UCI via a specific Tx burst, the UE can be configured to transmit the UCI in the second subframe (or a subframe appearing after the second subframe) of the Tx burst. In other word, when there is a Tx burst consisting of a plurality of subframes, the UE can be configured to transmit the UCI in a subframe rather than the first subframe of the Tx burst.

3.5.6. Sixth Example of the Method 5

When HARQ-ACK is transmitted on an unlicensed band, in order to solve a mismatch problem of a codebook size between a UE and an eNB, it is able to configure a HARQ-ACK codebook to be transmitted on the basis of a configured CC. Specifically, as mentioned earlier in the method 1, when a HARQ-ACK codebook of licensed bands is not separated from a HARQ-ACK codebook of unlicensed bands, although a HARQ-ACK codebook size is configured to be dynamically changed on the basis of an actually assigned CC (i.e., based on a counter DAI and the total DAI) (rather than a configured CC) for licensed bands, if HARQ-ACK is transmitted on an unlicensed band, a HARQ-ACK codebook can be configured on the basis of a (semi-statically) configured CC.

3.5.7. Seventh Example of the Method 5

When HARQ-ACK is transmitted on an unlicensed band, if a UE fails to perform LBT on the unlicensed band and the UE does not attempt to perform transmission, it may allow the UE to defer the HARQ-ACK transmission to a next subframe. Specifically, as mentioned earlier in the method 1 and the method 2, the operation above may not be allowed when licensed band HARQ-ACK is not separated from unlicensed band HARQ-ACK. In other word, according to the method 1 and the method 2, if a UE fails to perform LBT and does not attempt to perform transmission, the UE can be configured to drop the HARQ-ACK transmission without deferring the HARQ-ACK transmission to a next subframe.

3.5.8. Eighth Example of the Method 5

Unlike licensed band transmission, unlicensed band transmission is determined according to an LBT result. Hence, it is difficult to always guarantee UCI transmission transmitted on an unlicensed band. In consideration of this, when a UE transmits UCI on an unlicensed band (in particular, when the UE transmits UCI including HARQ-ACK on an unlicensed band), it is necessary for the UE to prepare UCI transmission on a licensed band in consideration of LBT failure on the unlicensed band. If the UE succeeds in performing LBT on the unlicensed band, the UE does not perform the prepared UCI transmission on the licensed band. If the UE fails to perform LBT on the unlicensed band, the UE can be configured to transmit UCI on a licensed band.

In this case, the method can be applied only when transmission on the unlicensed band is signaled to be started from a subframe boundary. Release-14 eLAA system considers indicating whether or not the first symbol of UL transmission is blanked via dynamic signaling. In particular, if the first symbol of the UL transmission is configured to be blanked via the signaling, the UL transmission can start from the second symbol while the first symbol is blanked for LBT. In particular, if an LBT result is determined at the timing later than a subframe boundary, since a licensed band operation always starts from a subframe boundary, it may be difficult to implement a UE that determines whether or not UCI is transmitted on a licensed band. In particular, it may consider performing the operation according to the eighth example of the method 5 only when the first symbol of UL transmission on an unlicensed band is signaled not to be blanked.

3.5.9. Ninth Example of the Method 5

In release-13 LAA system, when an eNB performs LBT to transmit PDSCH, the eNB can control a contention window size (CWS) based on HARQ-ACK. Specifically, if a ratio of NACK is equal to or greater than a prescribed level among HARQ-ACKs corresponding to PDSCH in a first full subframe (or a starting partial subframe and a next full subframe) of a DL Tx burst, the eNB increases a CWS. Otherwise, the eNB can be configured to reset the CWS.

In this case, the starting partial subframe corresponds to a subframe in which a signal is transmitted during 7 OFDM symbols corresponding to the second slot only among two slots constructing a subframe. In order to reliably receive a reference subframe, the eNB can configure a UE to transmit HARQ-ACK corresponding to the reference subframe via a licensed band (or licensed cell) only. In particular, the HARQ-ACK corresponding to the reference subframe can be transmitted on a licensed cell PUCCH. Or, if PUCCH/PUSCH simultaneous transmission is not configured, at least one licensed cell PUSCH is assigned to the UE at the timing of transmitting the HARQ-ACK to make the HARQ-ACK corresponding to the reference subframe to be piggybacked to the licensed cell PUSCH. Or, the eNB can update a CWS based on HARQ-ACK information fed back via a licensed cell only.

3.6. Method 6 [UL Transmission Configurability on Unlicensed Band]

According to a legacy LTE system, if a TDD (Time Division Duplex) carrier is set to a specific UE, the UE is able to perform DL reception or UL transmission on the carrier according to a DL/UL configuration. Although a frame structure type 3 is defined in LAA Scell, basically, DL and UL can be flexibly defined according to scheduling of an eNB on a single carrier. Hence, according to a legacy LTE system, if the LAA Scell is configured, a UE can be configured to perform DL reception and UL transmission on a corresponding carrier. However, although a UE (e.g., LTE-A PRO UE) is configured according to release-14 LTE system, it may be difficult for the UE to perform UL transmission in LAA Scell due to the reasons described in the following.
Although there are many component carriers (CCs) capable of performing DL/UL transmission on 5 GHz (compared to a licensed band), UL simultaneous transmission capability of a UE may be relatively less than the number of CCs of an available unlicensed band.
Simultaneous transmission of a licensed band PUCCH and an unlicensed band PUSCH can be defined as a mandatory feature of a UE due to a restriction that HARQ-ACK for a licensed band is not transmitted on an unlicensed band.

In particular, an eNB can enable the UE according to the release-14 system to perform DL reception only for the LAA Scell and disable UL transmission for the LAA SCell. In particular, the eNB can UE-specifically indicate whether the UL transmission is enabled or disabled in the LAA Scell via RRC signaling (or dynamic signaling).

And, the eNB can signal whether UL transmission is enabled or disabled in various LAA SCells according to a CC in consideration of UL transmission capacity of a UE.

And, the eNB can configure a UE to perform UL transmission in all configured LAA SCells. Instead, the eNB can receive signaling on the simultaneous maximum UL transmission capability in LAA Scell from the UE. The eNB may not schedule UL transmission capability equal to or greater than the maximum UL transmission capability to the UE at specific timing based on the signaling received from the UE and the UE may not expect scheduling of UL transmission capability equal to or greater than the maximum UL transmission capability at the specific timing. Or, although UL transmission capability equal to or greater than the maximum UL transmission capability is scheduled, the UE performs LBT on all scheduled CCs. If LBT is successfully performed on CCs equal to or greater than the capability, the UE may attempt to perform UL transmission on a part of the CCs (i.e., the number of CCs as much as the maximum UL transmission capability) only.

Or, the UE can be configured to report UL CA capability for a licensed band and UL CA capability of an unlicensed band, respectively. If a certain UE supports the maximum M number of UL CA for an unlicensed band (UE capability) and an eNB schedules the N (>=M) number of LAA Scells at the time same, the UE can be configured to perform UL transmission on the M number of LAA SCells only in an ascending order (or descending order) of a cell index among the N number of LAA Scells. Or, the UE can be configured to perform UL transmission on the K number of LAA SCells only on which LBT is successfully performed among the N number of LAA SCells (If K is greater than M, the UE can be configured to perform UL transmission on the M number of LAA Scells in an order of a cell index).

In the following, a method for a UE to transmit UCI proposed in the present invention is summarized.

A UE receives downlink control information (e.g., UL grant) for scheduling uplink signal transmission on a plurality of unlicensed bands in a specific subframe (e.g., N^{th} subframe) from a base station.

In this case, if the UE has UCI to be transmitted in the specific subframe, the UE transmits the UCI to the base station in the specific subframe via at least one or more unlicensed bands on which LBT (Listen-Before-Talk) is successfully performed among a plurality of the unlicensed bands.

For example, the UE can transmit the UCI via all unlicensed bands on which the LBT is successfully performed among a plurality of the unlicensed bands. In this case, the UCI transmitted via all unlicensed bands on which the LBT is successfully performed may correspond to identically repeated information.

As a different example, the UE can transmit the UCI via an unlicensed band corresponding to the UCI among the at least one or more unlicensed bands on which the LBT is successfully performed. In other word, when the UE transmit UCI on a specific unlicensed band, the UE can configure the UCI to be transmitted via the specific unlicensed band only. In this case, since the UE is able to transmit an uplink signal via an unlicensed band on which the LBT is successfully performed only due to the characteristic of an unlicensed band, the UE can transmit the UCI via the specific unlicensed band only when the LBT is successfully performed on the specific unlicensed band.

Specifically, if the UCI is configured by a plurality of sub-UCIs respectively corresponding to a plurality of unlicensed bands, the UE can transmit each of a plurality of the sub-UCIs via a corresponding unlicensed band. Similar to the aforementioned description, due to the characteristic of an unlicensed band, the UE can transmit sub-UCIs corresponding to unlicensed bands on which LBT is successfully performed only via a corresponding unlicensed band.

As a further different example, the UE can transmit UCI via at least one or more unlicensed bands on which LBT is successfully performed only when the UCI includes aperiodic channel state information. In this case, the UE can transmit the UCI via an unlicensed band corresponding to the UCI including the aperiodic channel state information.

As a further different example, if the UE fails to perform LBT on at least one unlicensed band among a plurality of the unlicensed bands, the UE can drop UCI transmission.

As a further different example, if the UE transmits a signal on unlicensed bands prior to the specific subframe, the UE can transmit the UCI via one or more unlicensed bands among the unlicensed bands on which the signal is transmitted.

Uplink control information according to the abovementioned examples can include at least one selected from the group consisting of a rank indicator (RI), a precoding matrix indicator (PMI), a beam indicator (BI), channel quality information (CQI), channel state information (CSI), and reception confirmation information.

In particular, the aforementioned examples can include a configuration that the UE transmits the UCI by piggybacking the UCI on PUSCH. Or, the aforementioned example can include a configuration that the UE transmits the UCI via PUCCH.

Since it is able to include the examples for the proposed method as one of implementation methods of the present invention, it is apparent that the examples are considered as a sort of proposed methods. Although the embodiments of the present invention can be independently implemented, the embodiments can also be implemented in a combined/aggregated form of a part of embodiments. It may define a rule that an eNB informs a UE of information on whether to apply the proposed methods (or, information on rules of the proposed methods) via a predefined signal (e.g., physical layer signal or higher layer signal).

4. Device Configuration

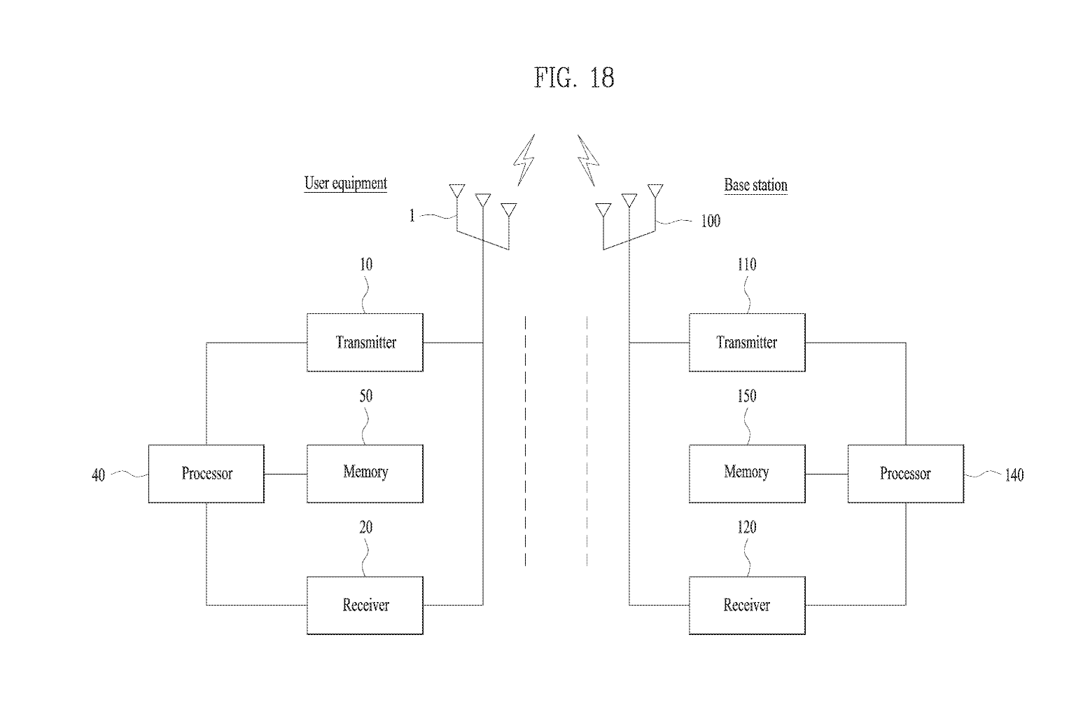

FIG. 18 is a diagram illustrating configurations of a UE and a base station capable of being implemented by the embodiments proposed in the present invention. The UE and the base station shown in FIG. 18 operate to implement the embodiments of a method of transmitting and receiving uplink control information between the UE and the base station.

A UE 1 may act as a transmission end on a UL and as a reception end on a DL. A base station (eNB) 100 may act as a reception end on a UL and as a transmission end on a DL.

That is, each of the UE and the base station may include a Transmitter (Tx) 10 or 110 and a Receiver (Rx) 20 or 120, for controlling transmission and reception of information, data, and/or messages, and an antenna 30 or 130 for transmitting and receiving information, data, and/or messages.

Each of the UE and the base station may further include a processor 40 or 140 for implementing the afore-described embodiments of the present disclosure and a memory 50 or 150 for temporarily or permanently storing operations of the processor 40 or 140.

The UE receives downlink control information from the base station via the processor 40 to schedule uplink signal transmission on a plurality of unlicensed bands in an N^{th} (N is a natural number) subframe via a first unlicensed band. If there is uplink control information to be transmitted in the N^{th} subframe, the UE can be configured to transmit the uplink control information in the N^{th} subframe via at least one unlicensed band on which LBT (Listen-Before-Talk) is successfully performed among a plurality of the unlicensed bands.

The Tx and Rx of the UE and the base station may perform a packet modulation/demodulation function for data transmission, a high-speed packet channel coding function, OFDM packet scheduling, TDD packet scheduling, and/or channelization. Each of the UE and the base station of FIG. 18 may further include a low-power Radio Frequency (RF)/Intermediate Frequency (IF) module.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a Multi Mode-Multi Band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g. CDMA 2000, WCDMA, etc.).

Embodiments of the present disclosure may be achieved by various means, for example, hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present disclosure may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The embodiments of the present invention can be applied to various wireless access systems including 3GPP (3rd Generation Partnership Project) and 3GPP2 system. The embodiments of the present invention can be applied not only to various wireless access systems but also to all technical fields to which the various wireless access systems are applied. Further, the proposed method can also be applied to an mmWave communication system using ultrahigh frequency band.

What is claimed is:

1. A method of transmitting uplink control information, which is transmitted by a user equipment to a base station in a wireless communication system supporting an unlicensed band, the method comprising:
receiving from the base station, downlink control information scheduling uplink signal transmission on a plurality of unlicensed bands in an N^{th} (N is a natural number) subframe; and
when there is uplink control information to be transmitted in the N^{th} subframe, transmitting the uplink control information in the N^{th} subframe via at least one or more unlicensed band on which LBT (Listen-Before-Talk) is successfully performed among a plurality of the unlicensed bands.

2. The method of claim 1, wherein the transmission of the uplink control information comprises transmission of the uplink control information transmitted via all unlicensed bands on which the LBT is successfully performed among a plurality of the unlicensed bands.

3. The method of claim 2, wherein the uplink control information transmitted via all unlicensed bands on which the LBT is successfully performed are all the same.

4. The method of claim 1, wherein the uplink control information is transmitted via a corresponding unlicensed band among the at least one or more unlicensed bands on which the LBT is successfully performed.

5. The method of claim 4, wherein if the uplink control information is configured by a plurality of sub-uplink control information respectively corresponding to a plurality of the unlicensed bands, each of a plurality of the sub-uplink control information is transmitted via a corresponding unlicensed band among the at least one or more unlicensed bands on which the LBT is successfully performed.

6. The method of claim 1, wherein the uplink control information is transmitted via the at least one or more unlicensed bands on which the LBT is successfully performed only when the uplink control information contains aperiodic channel state information.

7. The method of claim 6, wherein the uplink control information containing the aperiodic channel state information is transmitted via an unlicensed band corresponding to the uplink control information among the at least one or more unlicensed bands on which the LBT is successfully performed.

8. The method of claim 1, wherein if it fails to perform the LBT on one or more unlicensed bands among a plurality of the unlicensed bands, the uplink control information is not transmitted.

9. The method of claim 1, wherein if the user equipment transmits a signal on at least one or more unlicensed bands prior to the N^{th} subframe, the uplink control information is transmitted via the at least one or more unlicensed bands on which the signal is transmitted.

10. The method of claim 1, wherein the uplink control information comprises at least one selected from the group consisting of a rank indicator (RI), a precoding matrix indicator (PMI), a beam indicator (BI), channel quality information (CQI), channel state information (CSI), and reception confirmation information.

11. The method of claim 1, wherein the uplink control information is transmitted via a physical uplink shared channel (PUSCH).

12. A method of transmitting uplink control information, which is transmitted by a user equipment to a base station in a wireless communication system supporting an unlicensed band, the method comprising:
receiving from the base station, downlink control information scheduling uplink signal transmission on at least one or more unlicensed bands in an N^{th} (N is a natural number) subframe; and
when there is uplink control information to be transmitted in the N^{th} subframe, transmitting the uplink control information in the N^{th} subframe via at least one or more unlicensed band on which LBT (Listen-Before-Talk) is successfully performed among a plurality of the unlicensed bands.

13. The method of claim 12, wherein the uplink control information transmitted via the at least one or more unlicensed bands on which the LBT is successfully performed are all the same.

14. The method of claim 12, wherein the uplink control information comprises at least one selected from the group consisting of a rank indicator (RI), a precoding matrix indicator (PMI), a beam indicator (BI), channel quality information (CQI), channel state information (CSI), and reception confirmation information.

15. The method of claim 12, wherein the uplink control information is transmitted via a physical uplink shared channel (PUSCH).

16. A user equipment receiving a downlink signal from a base station in a wireless communication system supporting an unlicensed band, the user equipment comprising:
a receiver;
a transmitter; and
a processor configured to operate in a manner of being connected with the receiver and the transmitter,
wherein the processor is configured to:
receive from the base station, downlink control information scheduling uplink signal transmission on a plurality of unlicensed bands in an N^{th} (N is a natural number) subframe; and
when there is uplink control information to be transmitted in the N^{th} subframe, transmit the uplink control information in the N^{th} subframe via at least one or more unlicensed band on which LBT (Listen-Before-Talk) is successfully performed among a plurality of the unlicensed bands.

17. A user equipment receiving a downlink signal from a base station in a wireless communication system supporting an unlicensed band, the user equipment comprising:
a receiver;
a transmitter; and
a processor configured to operate in a manner of being connected with the receiver and the transmitter,
wherein the processor configured to:
receive from the base station, downlink control information scheduling uplink signal transmission on at least one or more unlicensed bands in an N^{th} (N is a natural number) subframe; and
when there is uplink control information to be transmitted in the N^{th} subframe, transmit the uplink control information in the N^{th} subframe via at least one or more unlicensed band on which LBT (Listen-Before-Talk) is successfully performed among a plurality of the unlicensed bands.
